(19) United States
(12) Patent Application Publication
(10) Pub. No.: US 2024/0125994 A1
(43) Pub. Date: Apr. 18, 2024

(54) LIGHT ABSORPTION ANISOTROPIC FILM, OPTICAL FILM, AND IMAGE DISPLAY DEVICE

(71) Applicant: FUJIFILM Corporation, Tokyo (JP)

(72) Inventors: Wataru HOSHINO, Kanagawa (JP); Shinichi YOSHINARI, Kanagawa (JP); Shinya WATANABE, Kanagawa (JP)

(73) Assignee: FUJIFILM Corporation, Tokyo (JP)

(21) Appl. No.: 18/528,187

(22) Filed: Dec. 4, 2023

Related U.S. Application Data
(63) Continuation of application No. PCT/JP2022/021318, filed on May 25, 2022.

(30) Foreign Application Priority Data
Jun. 25, 2021 (JP) 2021-105898

(51) Int. Cl. G02B 5/30; G02B 5/00

(52) U.S. Cl. CPC G02B 5/3016; G02B 5/003

(57) ABSTRACT

A light absorption anisotropic film that, when being applied to an image display device, it is easy to control a region where visibility is high and a region where visibility is low and viewing angle controllability is more excellent, an optical film, and an image display device. The light absorption anisotropic film contains a dichroic substance and a liquid crystal compound, in which the light absorption anisotropic film has a plurality of regions having different directions of transmittance central axes in an in-plane direction of the light absorption anisotropic film, in the plurality of regions, all angles θ between the transmittance central axes and a normal direction of a surface of the light absorption anisotropic film are in a range of 0° to 70°, and any of a specific requirement 1, a specific requirement 2, or a specific requirement 3 is satisfied.

### CROSS-REFERENCE TO RELATED APPLICATIONS

This application is a Continuation of PCT International Application No. PCT/JP2022/021318 filed on May 25, 2022, which claims priority under 35 U.S.C. § 119(a) to Japanese Patent Application No. 2021- 105898 filed on Jun. 25, 2021. The above applications are hereby expressly incorporated by reference, in their entirety, into the present application.

### BACKGROUND OF THE INVENTION

### 1. Field of the Invention

The present invention relates to a light absorption anisotropic film, an optical film, and an image display device.

### 2. Description of the Related Art

An image display device has been used in various scenes, and it may be required to control a viewing angle for the purpose of preventing peeping into the image display device, preventing reflected glare of an image, and the like depending on applications of the image display device.

For example, JP 2009- 145776A discloses a viewing angle control system including a polarizer (light absorption anisotropic film) which contains a dichroic substance, in which an angle between an absorption axis and a normal line of a film surface is 0° to 45°.

### SUMMARY OF THE INVENTION

In recent years, the image display device is required to more strictly control the viewing angle. For example, in a case where the image display device is used as an in-vehicle display such as a car navigation system, there is a request that visibility of a region where information useful for a driver is displayed is increased, and visibility of a region where information not useful for the driver is displayed is decreased. In addition, regarding the driver and occupants other than the driver, for one person, it is desirable to increase the visibility by accurately and quickly viewing a screen to obtain the information, but for the other person, it is not necessary to visually recognize the screen, and there is a demand for lowering the visibility of the screen in order to obstruct the field of view. In this manner, there is a demand for more advanced control of the viewing angle of the image display device.

As a result of studying the viewing angle control system disclosed in JP 2009-145776A, the present inventors have found that there is room for improvement in viewing angle controllability for controlling visibility in a case of observing a displayed image according to a viewing angle.

The present invention has been made in consideration of the above-described circumstances, and an object of the present invention is to provide a light absorption anisotropic film that, in a case of being applied to an image display device, it is easy to control a region where visibility is high and a region where visibility is low and viewing angle controllability is more excellent.

Another object of the present invention is to provide an optical film and an image display device.

The present inventors have found that the above-described objects can be achieved by the following configurations.

[1] Alight absorption anisotropic film comprising:

a dichroic substance; and

a liquid crystal compound,

in which the light absorption anisotropic film has a plurality of regions having different directions of transmittance central axes in an in-plane direction of the light absorption anisotropic film,

in the plurality of regions, all angles θ between the transmittance central axes and a normal direction of a surface of the light absorption anisotropic film are in a range of 0° to 70° , and

any of a requirement 1, a requirement 2, or a requirement 3 described later is satisfied.

[2] The light absorption anisotropic film according to [1],

in which the requirement 1 or the requirement 2 is satisfied.

[3] The light absorption anisotropic film according to [2],

in which the angles 0 increase in a stepwise manner or a continuous manner or decrease in a stepwise manner or a continuous manner as proceeding in the in-plane direction in which the plurality of regions are arranged.

[4] The light absorption anisotropic film according to [2] or [3],

in which the angles 0 in the light absorption anisotropic film increase in a continuous manner or decrease in a continuous manner as proceeding in the in-plane direction in which the plurality of regions are arranged.

[5] The light absorption anisotropic film according to [1],

in which the requirement 3 is satisfied.

[6] The light absorption anisotropic film according to [5],

in which, as proceeding from a first region included in the at least two regions toward another region other than the first region along the in-plane direction in which the at least two regions are arranged, angles φ between the directions of orthographic projection of the transmittance central axes and the in-plane direction increase in a stepwise manner or a continuous manner or decrease in a stepwise manner or a continuous manner.

[7] The light absorption anisotropic film according to [5] or [6],

in which, as proceeding from a first region included in the at least two regions toward another region other than the first region along the in-plane direction in which the at least two regions are arranged, angles φ between the directions of orthographic projection of the transmittance central axes and the in-plane direction increase in a continuous manner or decrease in a continuous manner.

[8] An optical film comprising:

the light absorption anisotropic layer according to any one of [1] to [7]; and

an alignment film.

[9] The optical film according to [8], further comprising:

a resin film containing polyvinyl alcohol or polyimide.

An image display device comprising:

a display panel; and

the optical film according to [8] or [9], which is disposed on one main surface of the display panel.

According to the present invention, it is possible to provide a light absorption anisotropic film that, in a case of being applied to an image display device, it is easy to control a region where visibility is high and a region where visibility is low and viewing angle controllability is more excellent.

In addition, according to the present invention, it is possible to provide an optical film and an image display device.

### BRIEF DESCRIPTION OF THE DRAWINGS

FIG. 1A is a conceptual view showing an example of an embodiment of the light absorption anisotropic film.

FIG. 1B is a conceptual view showing the example of the embodiment of the light absorption anisotropic film.

FIG. 2A is a conceptual view showing another example of an embodiment of the light absorption anisotropic film.

FIG. 2B is a conceptual view showing another example of the embodiment of the light absorption anisotropic film.

FIG. 3 is a conceptual view showing still another example of an embodiment of the light absorption anisotropic film.

FIG. 4A is a conceptual view showing still another example of an embodiment of the light absorption anisotropic film.

FIG. 4B is a conceptual view showing still another example of the embodiment of the light absorption anisotropic film.

FIG. 4C is a conceptual view showing still another example of the embodiment of the light absorption anisotropic film.

FIG. 5A is a conceptual view showing an example of a photo alignment treatment performed in a manufacturing method of a light absorption anisotropic film.

FIG. 5B is a conceptual view showing the example of the photo alignment treatment performed in the manufacturing method of a light absorption anisotropic film.

FIG. 5C is a conceptual view showing the example of the photo alignment treatment performed in the manufacturing method of a light absorption anisotropic film.

FIG. 6A is a conceptual view showing another example of a photo alignment treatment performed in the manufacturing method of a light absorption anisotropic film.

FIG. 6B is a conceptual view showing another example of the photo alignment treatment performed in the manufacturing method of a light absorption anisotropic film.

FIG. 6C is a conceptual view showing another example of the photo alignment treatment performed in the manufacturing method of a light absorption anisotropic film.

FIG. 7 is a conceptual view showing still another example of a photo alignment treatment performed in the manufacturing method of a light absorption anisotropic film.

FIG. 8A is a conceptual view showing still another example of a photo alignment treatment performed in the manufacturing method of a light absorption anisotropic film.

FIG. 8B is a conceptual view showing still another example of the photo alignment treatment performed in the manufacturing method of a light absorption anisotropic film.

FIG. 9 is a conceptual view showing an example of an embodiment of an image display device.

FIG. 10 is a conceptual view showing another example of an embodiment of the image display device.

FIG. 11A is a diagram for describing an evaluation method of the image display device.

FIG. 11B is a diagram for describing the evaluation method of the image display device.

### DESCRIPTION OF THE PREFERRED EMBODIMENTS Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in the present specification, a term “parallel” does not indicate parallel in a strict sense, but indicates a range of ±5° from parallel.

In addition, in the present specification, a term “orthogonal” or “perpendicular” does not indicate orthogonal or perpendicular in a strict sense, but indicates that an angle is in a range of 90±5°.

In the present specification, a term “(meth)acrylic” is used to mean “either one or both of acrylic and methacrylic”. A term “(meth)acryloyl” is used to mean “either one or both of acryloyl and methacryloyl”.

A bonding direction of a divalent group (for example, —COO—) described in the present specification is not particularly limited. For example, in a case where L in X—L—Y is —COO— and in a case where the position bonded to the X side is defined as *1 and the position bonded to the Y side is defined as *2, L may be *1-O—CO-*2 or *1-CO—O—*2.

### Light Absorption Anisotropic Film

The light absorption anisotropic film according to the embodiment of the present invention contains a dichroic substance and a liquid crystal compound, in which the light absorption anisotropic film has a plurality of regions having different directions of transmittance central axes in an in-plane direction of the light absorption anisotropic film, in the plurality of regions, all angles θ between the transmittance central axes and a normal direction of a surface of the light absorption anisotropic film are in a range of 0° to 70°, and any of a requirement 1, a requirement 2, or a requirement 3 is satisfied.

Requirement 1: angle θ in at least one of the plurality of regions is 0°,

Requirement 2: in at least two regions among the plurality of regions, directions of orthographic projection of the transmittance central axes onto the surface of the light absorption anisotropic film are the same, and in the at least two regions, the angles θ are different from each other,

Requirement 3: in at least two regions among the plurality of regions, the angles θ are the same, and in the at least two regions, directions of orthographic projection of the transmittance central axes onto the surface of the light absorption anisotropic film are different from each other.

Here, the transmittance central axis denotes a direction in which a transmittance is highest in a case where the transmittance is measured by changing an inclination angle and an inclination direction with respect to the normal direction of the surface of the light absorption anisotropic film. The transmittance central axis is measured by irradiating the light absorption anisotropic film with P-polarized light having a wavelength of 550 nm using an ultraviolet-visible-infrared spectrophotometer (for example, “JASCO V-670/ARMN-735” (manufactured by JASCO Corporation)). The specific method thereof is as follows.

First, a direction in which the transmittance central axis is tilted with respect to a normal line of a surface of the light absorption anisotropic film is initially searched for. More specifically, a sample of the light absorption anisotropic film is cut into, for example, a square with a size of 4 cm square, and the obtained sample is set on a sample table of an optical microscope in which a linear polarizer is disposed on a light source side (for example, product name “ECLIPSE E600 POL”, manufactured by Nikon Corporation). Next, the absorbance of the sample at a wavelength of 550 nm is monitored while the sample table is allowed to rotate clockwise by 1° using a multi-channel spectroscope (for example, product name “QE65000”, manufactured by Ocean Optics), and the direction in which the absorbance is maximized is confirmed. An angle φ of the light absorption anisotropic film is acquired based on the direction in which the absorbance of the sample is maximized in the plane.

Next, in a plane including the normal line of the light absorption anisotropic film along the direction in which the transmittance is maximized (plane including the transmittance central axis and perpendicular to the surface of the layer), the light absorption anisotropic film is irradiated with the P-polarized light having a wavelength of 550 nm while changing an angle θ (polar angle) with respect to the normal line of the surface of the light absorption anisotropic film from 0° to 70° in 0.5° increments, thereby measuring a transmittance of the light absorption anisotropic film. A direction in which the transmittance obtained by the measurement is highest is the transmittance central axis, and the angle θ between the transmittance central axis and the normal line of the surface of the light absorption anisotropic film is acquired.

In a case where the direction in which the absorbance is maximized cannot be clearly confirmed by the first measurement of the angle φ, assuming that the direction of the transmittance central axis is along the normal direction of the surface of the light absorption anisotropic film, the above-described angle θ is measured with respect to an arbitrary plane including the normal line of the light absorption anisotropic film, and it is confirmed that the angle θ is 0°.

Hereinafter, the light absorption anisotropic film according to the embodiment of the present invention will be described based on specific embodiments with reference to the drawings. It should be noted that the present invention is not limited to the following embodiments.

### First Embodiment

Examples of one embodiment of the light absorption anisotropic film according to the present invention include a light absorption anisotropic film satisfying the above-described requirement 1 or the above-described requirement 2.

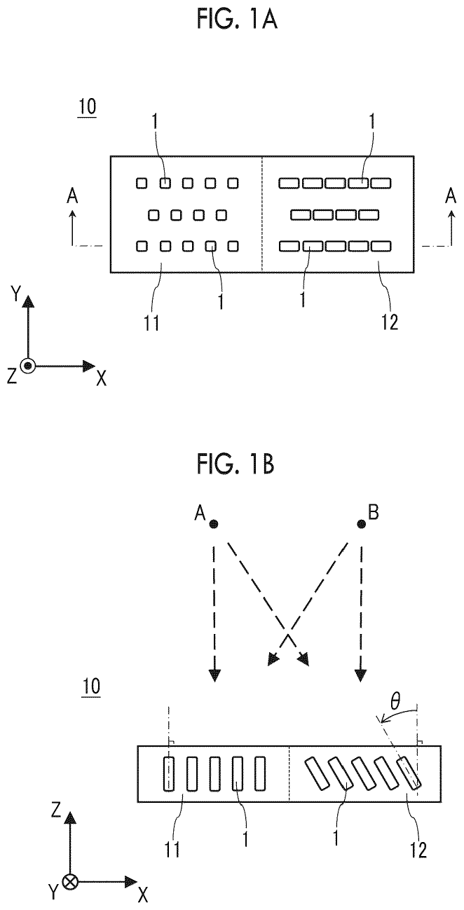

FIG. 1A and FIG. 1B (hereinafter, collectively referred to as “FIG. 1”) are conceptual views showing an example of a configuration of the light absorption anisotropic film according to the present embodiment.

A light absorption anisotropic film 10 shown in FIG. 1 contains a dichroic substance 1 and a liquid crystal compound (not shown), and in the light absorption anisotropic film 10, a first region 11 and a second region 12 are arranged side by side in an in-plane X-axis direction.

FIG. 1A is a plan view of the light absorption anisotropic film 10 observed from a normal direction of a surface of the light absorption anisotropic film 10. In addition, FIG. 1B is a cross-sectional view of the light absorption anisotropic film 10 taken along a line A-A shown in FIG. 1A.

Here, as shown in FIG. 1A, among in-plane directions of the elongated light absorption anisotropic film 10, a longitudinal direction of the light absorption anisotropic film 10 (left-right direction of a paper plane) is set to an X-axis, a direction which is the in-plane direction of the light absorption anisotropic film 10 and is perpendicular to the X-axis (up-down direction of the paper plane) is set to a Y-axis, and a normal direction of the light absorption anisotropic film 10 (direction perpendicular to the paper plane) is a Z-axis. In addition, a direction of the X-axis toward the right of the paper plane is defined as a positive direction of the X-axis, a direction of the Y-axis upward the paper plane is defined as a positive direction of the Y-axis, and a direction of the Z-axis toward the front from the paper plane is defined as a positive direction of the Z-axis.

In addition, the angle θ (polar angle) between the direction of the transmittance central axis and the normal direction of the surface of the light absorption anisotropic film 10 increases as it approaches the light absorption anisotropic film 10 with the positive direction of the Z-axis as a reference (θ=0°, and it is defined that the angle θ is 90° in the in-plane direction of the light absorption anisotropic film 10.

In addition, regarding the angle φ (azimuthal angle) in the direction in which orthographic projection of the transmittance central axis extends in the plane of the light absorption anisotropic film 10 shown in FIG. 1, it is defined that the angle φ increases as the rotation is clockwise with the direction extending in a negative direction of the X-axis as a reference (θ=0°). In a case where the angle θ in one direction is 0° as in the inclination of a major axis of the dichroic substance 1 contained in the first region 11 in FIG. 1B, since the angle φ in this direction cannot be specified, it is assumed that it does not exist.

In the present specification, unless otherwise specified, the X-axis, the Y-axis, the Z-axis, the angle θ, and the angle φ are in accordance with the above-described definitions.

As shown in FIG. 1, in the first region 11 and the second region 12 of the light absorption anisotropic film 10, directions in which the dichroic substances 1 are aligned in the regions are different from each other. More specifically, in the first region 11, an orientation of the major axis of the dichroic substance 1 is parallel to the Z-axis, and in the second region 12, an orientation of the major axis of the dichroic substance 1 is inclined at the angle θ from the positive direction of the Z-axis toward the negative direction of the X-axis. Therefore, since the light absorption anisotropic film 10 includes the first region 11 in which the angle θ between the transmittance central axis and the normal direction of the light absorption anisotropic film 10 is 0° and the second region 12 in which the angle θ between the transmittance central axis and the normal direction of the light absorption anisotropic film 10 is more than 0°, the requirement 1 is satisfied.

By applying such a light absorption anisotropic film 10 to an image display device, a region where visibility is high and a region where visibility is low are easily controlled, and viewing angle controllability of the image display device can be further improved.

For example, in a case where a displayed image of an image display device on which the light absorption anisotropic film 10 shown in FIG. 1 is laminated is observed from a position A (see FIG. 1B) located in front of the first region 11 (normal direction of the first region 11), since the transmittance central axis of the first region 11 and the transmittance central axis of the second region 12 are oriented in the direction of the position A, the transmittance in both regions is increased and visibility of the displayed image in both regions is improved. Meanwhile, in a case where the displayed image thereof is observed from a position B (see FIG. 1B) located in front of the second region 12 (normal direction of the second region 12), since the transmittance of the first region 11 and the transmittance of the second region 12 are lower than that in the case of being observed from the position A, the visibility of the displayed image in both regions is also lowered.

As described above, since the light absorption anisotropic film 10 shown in FIG. 1 includes the first region 11 in which the angle θ between the transmittance central axis and the positive direction of the Z-axis is 0° and the second region 12 in which the angle θ between the transmittance central axis and the positive direction of the Z-axis is more than 0°, the requirement 1 is satisfied.

The angle θ in this case is not particularly limited as long as it is in a range of more than 0° and 70° or less and is appropriately selected depending on the image display device to be applied, but from the viewpoint that a practical viewing angle is more excellent, the angle θ is preferably 1° to 60°, more preferably 5° to 40°, and still more preferably 8° to 45°.

An aspect in which, in the light absorption anisotropic film 10 shown in FIG. 1, there are two regions where the angles θ between the transmittance central axes and the normal direction of the light absorption anisotropic film 10 are respectively 0° or more than 0° has been described, of the light absorption anisotropic film according to the present embodiment is not limited to this aspect. The light absorption anisotropic film may include three or more regions where the angles θ between the transmittance central axes and the normal direction of the light absorption anisotropic film are different from each other.

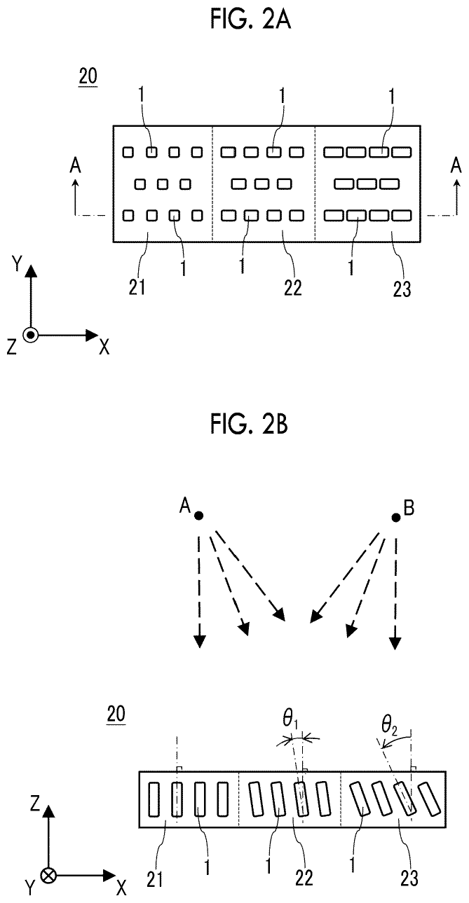

FIG. 2A and FIG. 2B (hereinafter, collectively referred to as “FIG. 2”) are conceptual views showing another example of a configuration of the light absorption anisotropic film according to the present embodiment.

A light absorption anisotropic film 20 shown in FIG. 2 contains a dichroic substance 1 and a liquid crystal compound (not shown), and in the light absorption anisotropic film 20, a first region 21, a second region 22, and a third region 23 are arranged side by side in an in-plane X-axis direction.

FIG. 2A is a plan view of the light absorption anisotropic film 20 observed from a normal direction of a surface of the light absorption anisotropic film 20. In addition, FIG. 2B is a cross-sectional view of the light absorption anisotropic film 20 taken along a line A-A shown in FIG. 2A.

As shown in FIG. 2, in the first region 21, the second region 22, and the third region 23 of the light absorption anisotropic film 20, directions in which the dichroic substances 1 are aligned in the regions are different from each other. More specifically, in the first region 21, an orientation of the major axis of the dichroic substance 1 is parallel to the Z-axis, and in the second region 22 and the third region 23, orientations of the major axes of the dichroic substance 1 are respectively inclined at an angle θ₁ or an angle θ₂ from the positive direction of the Z-axis toward the negative direction of the X-axis. In this case, a relationship of the angle θ₁<the angle θ₂ is satisfied.

Therefore, since the light absorption anisotropic film 20 includes the first region 21 in which the angle θ between the transmittance central axis and the normal direction of the light absorption anisotropic film 20 is 0° and the second region 22 and the third region 23 in which the angles θbetween the transmittance central axes and the normal direction of the light absorption anisotropic film 20 are more than 0°, the above-described requirement 1 is satisfied.

In addition, in the second region 22 and the third region 23 of the light absorption anisotropic film 20, since directions of orthographic projection of the transmittance central axes are the same as the negative direction of the X-axis, and the angles θ between the transmittance central axes and the normal direction of the light absorption anisotropic film 20 are different from each other, the light absorption anisotropic film 20 satisfies the above-described requirement 2.

By applying such a light absorption anisotropic film 20 to an image display device, a region where visibility is high and a region where visibility is low are easily controlled, and viewing angle controllability of the image display device can be further improved.

For example, in a case where a displayed image of an image display device on which the light absorption anisotropic film 20 shown in FIG. 2 is laminated is observed from a position A (see FIG. 2B) located in front of the first region 21 (normal direction of the first region 21), since the transmittance central axis of the first region 21, the transmittance central axis of the second region 22, and the transmittance central axis of the third region 23 are oriented in the direction of the position A, the transmittance in these regions is increased and visibility of the displayed image in these regions is improved. Meanwhile, in a case where the displayed image thereof is observed from a position B (see FIG. 2B) located in front of the third region 23 (normal direction of the third region 23), since the transmittance of the first region 21, the transmittance of the second region 22, and the transmittance of the third region 23 are all lower than that in the case of being observed from the position A, the visibility of the displayed image in these regions is also lowered.

In addition, in the light absorption anisotropic film 20 shown in FIG. 2, the angles θ between the transmittance central axes and the normal direction of the light absorption anisotropic film 20 increase in a stepwise manner as proceeding in the positive direction of the X-axis in which the first region 21, the second region 22, and the third region 23 are arranged.

As described above, in the light absorption anisotropic film, in a case where the angles θ increase in a stepwise manner or a continuous manner or decrease in a stepwise manner or a continuous manner as proceeding in the in-plane direction in which a plurality of regions having different angles θ are arranged, the visibility of the image display device is more excellent, which is preferable.

In the present specification, the “increase in a continuous manner” or the “decrease in a continuous manner” means that, in one in-plane direction, the angle θ or the angle φ increases or decreases continuously within a range of 2° or less per 1 cm.

As described above, the light absorption anisotropic film 20 shown in FIG. 2 satisfies the requirement 2. In the light absorption anisotropic film satisfying the requirement 2, the angle θ between the transmittance central axis and the normal direction of the light absorption anisotropic film (the angles θ₁ and θ₂ in the light absorption anisotropic film 20 shown in FIG. 2) is not particularly limited as long as it is in a range of more than 0° and 70° or less, but from the viewpoint that the visibility of the image display device is more excellent, the angle θ is preferably 1° to 60°, more preferably 5° to 40°, and still more preferably 8 ° to 45 ° .

An aspect in which, in the light absorption anisotropic film 10 shown in FIG. 1 and the light absorption anisotropic film 20 shown in FIG. 2, there is the angle θ between the transmittance central axis and the normal direction of the light absorption anisotropic film in each region changes in a stepwise manner has been described, but the light absorption anisotropic film according to the present embodiment is not limited to this aspect. The angles θ between the transmittance central axes and the normal direction of the light absorption anisotropic film may change in a continuous manner.

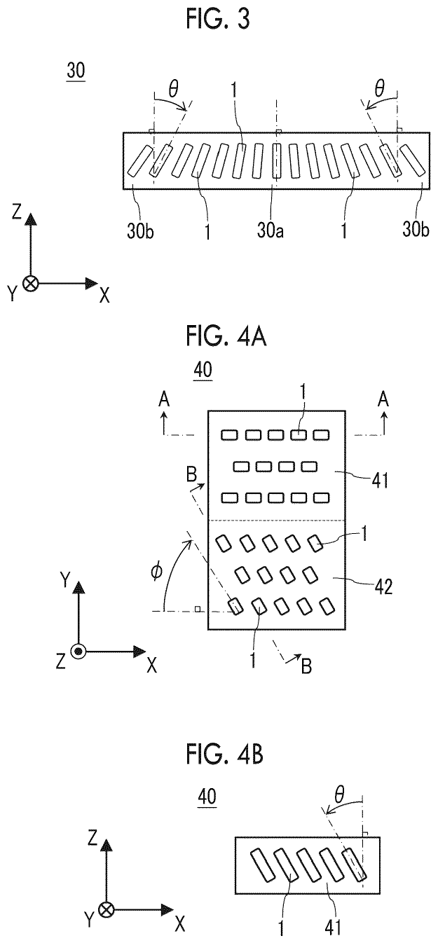

FIG. 3 is a conceptual view showing still another example of a configuration of the light absorption anisotropic film according to the present embodiment.

A light absorption anisotropic film 30 shown in FIG. 3 contains a dichroic substance 1 and a liquid crystal compound (not shown). Here, FIG. 3 is a cross-sectional view of the light absorption anisotropic film 30 in a plane that includes a normal line of a surface of the light absorption anisotropic film 30 and includes, among in-plane directions, an X-axis direction in which an inclination of a major axis of the dichroic substance 1 changes.

As shown in FIG. 3, the major axis of the dichroic substance 1 contained in the light absorption anisotropic film 30 is inclined at different angles with respect to the normal direction of the light absorption anisotropic film 30 depending on a position in the in-plane X-axis direction. Although not shown in the drawing, the inclination of the major axis of the dichroic substance 1 contained in the light absorption anisotropic film 30 does not change in the in-plane Y-axis direction.

As shown in FIG. 3, the light absorption anisotropic film 30 has different directions in which the dichroic substance 1 is aligned depending on the position in the X-axis direction. More specifically, in a center portion 30a of the light absorption anisotropic film 30 in the X-axis direction, an orientation of the major axis of the dichroic substance 1 is parallel to the Z-axis, and the orientation of the major axis of the dichroic substance 1 increases in a continuous manner from the center portion 30a toward an end portion 30b of the light absorption anisotropic film 30 in the X-axis direction.

Here, in the light absorption anisotropic film 30, since the angle θ between the transmittance central axis and the normal direction of the light absorption anisotropic film 30 in the center portion 30a is 0°, the above-described requirement 1 is satisfied.

In addition, in a region of the light absorption anisotropic film 30, other than the center portion 30a, since directions of orthographic projection of the transmittance central axes are the X-axis direction, and the angles θ between the transmittance central axes and the normal direction of the light absorption anisotropic film 30 are different from each other, the light absorption anisotropic film 30 satisfies the above-described requirement 2.

By applying such a light absorption anisotropic film 30 to an image display device, same as the above-described light absorption anisotropic films 10 and 20, a region where visibility is high and a region where visibility is low are easily controlled, and viewing angle controllability of the image display device can be further improved.

In addition, in the light absorption anisotropic film 30 shown in FIG. 3, the angles θ between the transmittance central axes and the normal direction of the light absorption anisotropic film 30 increase in a continuous manner as it approaches the end portion 30in the positive direction or negative direction of the X-axis from the center portion 30a in the longitudinal direction.

As described above, in the light absorption anisotropic film in which the angles θ increase in a continuous manner or decrease in a continuous manner as proceeding in the in-plane direction in which a plurality of regions having different angles θ are arranged, the visibility of the image display device is more excellent, which is more preferable.

In the light absorption anisotropic film according to the present embodiment, it is sufficient that a plurality of (two or more) regions having transmittance central axes at different angles θ with respect to the normal direction of the surface of the light absorption anisotropic film are present in the plane, and the number thereof is not particularly limited. That is, the number of regions described above may be 2 or more, and is preferably 3 or more. In addition, as described above, it is preferable to use an aspect in which the angle θ between the transmittance central axis and the normal direction of the surface of the light absorption anisotropic film changes continuously in the in-plane direction.

In the light absorption anisotropic film according to the present embodiment, an in-plane difference of the above-described angle θ in the light absorption anisotropic film is not particularly limited, and a difference between the minimum value and the maximum value of the above-described angle θ in the plane of the light absorption anisotropic film is preferably 3° to 140° and more preferably 5° to 120°.

In the light absorption anisotropic film according to the first embodiment shown in FIGS. 1 to 3, the directions of the orthographic projection of the transmittance central axes (orientations in the in-plane direction of the transmittance central axes) are the same in each region, but the light absorption anisotropic film according to the present embodiment may further include a region where the orthographic projection of the transmittance central axis is different, as long as the light absorption anisotropic film includes the plurality of regions satisfying the requirement 1 or the requirement 2.

### Second Embodiment

Examples of other embodiments of the light absorption anisotropic film according to the present invention include a light absorption anisotropic film satisfying the above-described requirement 3.

FIG. 4A and FIG. 4B (hereinafter, collectively referred to as “FIG. 4”) are conceptual views showing an example of a configuration of the light absorption anisotropic film according to the second embodiment.

A light absorption anisotropic film 40 shown in FIG. 4 contains a dichroic substance 1 and a liquid crystal compound (not shown), and in the light absorption anisotropic film 40, a first region 41 and a second region 42 are arranged side by side in an in-plane Y-axis direction.

FIG. 4A is a plan view of the light absorption anisotropic film 40 observed from a normal direction of a surface of the light absorption anisotropic film 40. In addition, FIG. 4B is a cross-sectional view of the light absorption anisotropic film 40 taken along a line A-A shown in FIG. 4A, and FIG. 4C is a cross-sectional view of the light absorption anisotropic film 40 taken along a line B-B shown in FIG. 4A.

With the light absorption anisotropic film 40 shown in FIG. 4, as shown in FIG. 4A, among in-plane directions of the elongated light absorption anisotropic film 40, a lateral direction of the light absorption anisotropic film 40 (left-right direction of a paper plane) is set to an X-axis, a direction which is the in-plane direction of the light absorption anisotropic film 40 and is perpendicular to the X-axis (up-down direction of the paper plane) is set to a Y-axis, and a normal direction of the light absorption anisotropic film 40 (direction perpendicular to the paper plane) is a Z-axis. In addition, as shown in FIG. 4A, a direction of the X-axis toward the right of the paper plane is defined as a positive direction of the X-axis, a direction of the Y-axis upward the paper plane is defined as a positive direction of the Y-axis, and a direction of the Z-axis toward the front from the paper plane is defined as a positive direction of the Z-axis.

As shown in FIG. 4, in the first region 41 and the second region 42 of the light absorption anisotropic film 40, directions in which the dichroic substances 1 are aligned in the regions are different from each other. More specifically, in both the first region 41 and the second region 42, it is the same that the major axis of the dichroic substance 1 is inclined at the angle θ with respect to the positive direction of the Z-axis. However, in the first region 41, a direction in which the major axis of the dichroic substance 1 is orthographically projected onto the surface (XY plane) of the light absorption anisotropic film 40 is parallel to the negative direction of the X-axis, but in the second region 42, a direction in which the major axis of the dichroic substance 1 is orthographically projected onto the surface (XY plane) of the light absorption anisotropic film 40 is a direction rotated clockwise by an angle φ from the negative direction of the X axis on the XY plane.

Accordingly, in the light absorption anisotropic film 40, since the angles θ between the transmittance central axes and the normal direction of the light absorption anisotropic film 40 are the same and the directions of orthographic projection of the transmittance central axes onto the surface of the light absorption anisotropic film 40 are different from each other, the requirement 3 is satisfied.

By applying the light absorption anisotropic film 40 according to the second embodiment shown in FIG. 4 to an image display device, same as the above-described light absorption anisotropic film according to the first embodiment, a region where visibility is high and a region where visibility is low are easily controlled, and viewing angle controllability of the image display device can be further improved.

The angle φ in this case is not particularly limited and is appropriately selected depending on the image display device to be applied, but it is preferable that the maximum value of a difference in angle φ between two regions having different angles φ is 5° to 12 0°.

Examples of an application situation of the image display device including the light absorption anisotropic film according to the second embodiment include an aspect in which an in-vehicle display such as a car navigation system is installed between a center of a dashboard (or center cluster) and a center console installed between the driver seat and passenger seat. In this case, it is conceivable to install the above-described image display device as an in-vehicle display in a region of 30 to 40 cm in the front direction of the vehicle, 30 to 40 cm in the horizontal direction, and 10 to 45 cm in the vertical direction, from the position of eyes of the driver. Examples of a suitable aspect of the light absorption anisotropic film according to the second embodiment, which is used in such an image display device, include an aspect in which an angle φ in the upper region of the light absorption anisotropic film laminated on the image display device is 0° to 30° (or 150° to 180°) and an angle φ in the lower region of the light absorption anisotropic film is 40° to 70° (or 110° to 140°).

The above-described aspect is merely an example of specific examples, and the directions of the angle θ and the angle φ in each region of the light absorption anisotropic film can be appropriately changed depending on the actual application situation of the image display device.

An aspect in which, in the light absorption anisotropic film 40 shown in FIG. 4, there are two regions with different directions of orthographic projection of the transmittance central axes has been described, but the light absorption anisotropic film according to the present embodiment is not limited to this aspect. The light absorption anisotropic film may include three or more regions with different directions of orthographic projection of the transmittance central axes.

In addition, in the light absorption anisotropic film 40 shown in FIG. 4, in a case where the direction of orthographic projection of the transmittance central axis in the first region 41 is set as a reference direction (φ=0°), the angles φ between the directions of orthographic projection of the transmittance central axes and the reference direction increase in a stepwise manner as proceeding in the negative direction of the Y-axis in which the first region 41 the second region 42 are arranged.

As described above, in the light absorption anisotropic film, in a case where the angles θ are the same and, as proceeding from a first region toward another region other than the first region along the in-plane direction in which at least two regions with different directions of orthographic projection of the transmittance central axes are arranged, the angles φ increase in a stepwise manner or a continuous manner or decrease in a stepwise manner or a continuous manner, the visibility of the image display device is more excellent, which is preferable.

The light absorption anisotropic film according to the present embodiment is not limited to the aspect in which the angle φ changes in a stepwise manner as shown in FIG. 4, and the angle φ may change continuously as proceeding in the in-plane direction in which a plurality of regions with different angles φ are arranged.

In addition, in the light absorption anisotropic film 40 shown in FIG. 4, the angles θ of the transmittance central axes with respect to the normal direction of the light absorption anisotropic film in each region are the same, but the light absorption anisotropic film according to the present embodiment may further include a region where the angle θ is not the same as long as the light absorption anisotropic film includes a plurality of regions satisfying the requirement 3.

In each of the light absorption anisotropic films shown in FIGS. 1 to 4, a plurality of regions with different directions of the transmittance central axes are arranged in only one in-plane direction, but the light absorption anisotropic film according to the embodiment of the present invention is not limited to this aspect. For example, the light absorption anisotropic film according to the embodiment of the present invention may have an aspect in which a plurality of regions with different directions of the transmittance central axes are arranged side by side in one in-plane direction and a plurality of regions with different directions of the transmittance central axes are arranged side by side in other in-plane direction.

In each of the light absorption anisotropic films shown in FIGS. 1 to 4, a plurality of the dichroic substances 1 are arranged in one in-plane direction, but this is shown to describe an alignment state of the dichroic substance 1, and is not intended to limit the light absorption anisotropic film according to the embodiment of the present invention to this aspect.

Examples of a technique of desirably aligning the dichroic substance to produce the light absorption anisotropic films according to the first embodiment and the second embodiment described above include a technique of producing a polarizer using the dichroic substance and a technique of producing a guest-host liquid crystal cell. For example, techniques used in the method of producing a dichroic polarizer, described in JP1999-305036A (JP-H11-305036A) and JP2002-090526A, and the method of producing a guest-host type liquid crystal display device, described in JP2002-099388A and JP2016-027387A, can be applied.

In order to prevent fluctuation of light absorption characteristics of the light absorption anisotropic film depending on the use environment, it is preferable that the alignment of the dichroic substance is fixed by forming a chemical bond. For example, the alignment of the dichroic substance can be fixed by promoting the polymerization of the host liquid crystal, the dichroic substance, or a polymerizable component to be added as desired.

A more specific manufacturing method of the above-described light absorption anisotropic film will be described later.

Hereinafter, composition and physical properties of the light absorption anisotropic film according to the embodiment of the present invention (hereinafter, also referred to as “present light absorption anisotropic film”) will be described in detail.

### Composition of Light Absorption Anisotropic Film

The present light absorption anisotropic film contains a dichroic substance and a liquid crystal compound, and has a plurality of regions where directions of transmittance central axes are different from each other in at least one in-plane direction.

The composition of the light absorption anisotropic film is not particularly limited as long as the light absorption anisotropic film exhibits the above-described characteristics, and known components contained in a light absorption anisotropic film can be applied.

### Dichroic Substance

In the present specification, the dichroic substance means a coloring agent having different absorbances depending on directions. The dichroic substance may be polymerized in the light absorption anisotropic film.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (dichroic coloring agents) can be used.

Specific examples thereof include dichroic substances described in paragraphs to [0071] of JP2013-228706A, paragraphs [0008] to [0026] of JP2013-227532A, paragraphs [0008] to [00015] of JP2013-209367A, paragraphs [0045] to [0058] of JP2013-014883A, paragraphs [0012] to [0029] of JP2013-109090A, paragraphs [009] to [0017] of JP2013-101328A, paragraphs [0051] to [0065] of JP2013-037353A, paragraphs [0049] to [0073] of JP2012-063387A, paragraphs [0016] to [0018] of JP1999-305036A (JP-H11-305036A), paragraphs [00009] to [0011] of JP2001-133630A, paragraphs [0030]to [0169]of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, and paragraphs [0014] to [0034] of WO2018/164252A.

In the light absorption anisotropic film, two or more kinds of dichroic substances may be used in combination. For example, from the viewpoint of making the color of the light absorption anisotropic film closer to black, it is preferable that at least one dichroic substance having a maximal absorption wavelength in a wavelength range of 370 nm or more and less than 500 nm and at least one dichroic substance having a maximal absorption wavelength in a wavelength range of 500 nm or more and less than 700 nm are used in combination.

As will be described later, the light absorption anisotropic film can be formed of a composition for forming a light absorption anisotropic film. In the composition for forming a light absorption anisotropic film, the dichroic substance may have a crosslinkable group. In a case where the dichroic substance has a crosslinkable group, the dichroic substance can be immobilized in a predetermined alignment state in a case of forming the light absorption anisotropic film using the composition for forming a light absorption anisotropic film.

Examples of the crosslinkable group include a (meth)acryloyl group, an epoxy group, an oxetanyl group, and a styryl group, and among these, a (meth)acryloyl group is preferable.

A content of the dichroic substance in the light absorption anisotropic film is not particularly limited, but from the viewpoint that, in a case of being applied to the image display device, it is easy to control a region where visibility is high and a region where visibility is low and viewing angle controllability is more excellent (hereinafter, also referred to “the effect of the present invention is more excellent”), the content is preferably 1% to 50% by mass and more preferably 10% to 25% by mass with respect to the total mass of the light absorption anisotropic film.

### Liquid Crystal Compound

The present light absorption anisotropic film contains a liquid crystal compound. In this manner, the dichroic substance can be aligned with a high alignment degree while precipitation of the dichroic substance is restrained.

As the liquid crystal compound, both a high-molecular-weight liquid crystal compound and a low-molecular-weight liquid crystal compound can be used, and from the viewpoint of increasing the alignment degree, a high-molecular-weight liquid crystal compound is preferable. In addition, the high-molecular-weight liquid crystal compound and the low-molecular-weight liquid crystal compound may be used in combination as the liquid crystal compound.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the high-molecular-weight liquid crystal compound include thermotropic liquid crystalline polymers described in JP2011-237513A and high-molecular-weight liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

From the viewpoint of further increasing the alignment degree of the obtained light absorption anisotropic film, a high-molecular-weight liquid crystal compound having a repeating unit represented by Formula (1) (hereinafter, also simply referred to as “repeating unit (1)”) is preferable as the liquid crystal compound.

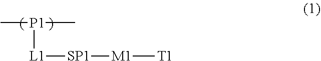

In Formula (1), P1 represents a main chain of the repeating unit, L1 represents a single bond or a divalent linking group, SP1 represents a spacer group, M1 represents a mesogen group, and T1 represents a terminal group.

Examples of the main chain of the repeating unit, represented by P1, include groups represented by Formulae (P1-A) to (P1-D). Among these, from the viewpoint of diversity and handle ability of a monomer serving as a raw material, a group represented by Formula (P1-A) is preferable.

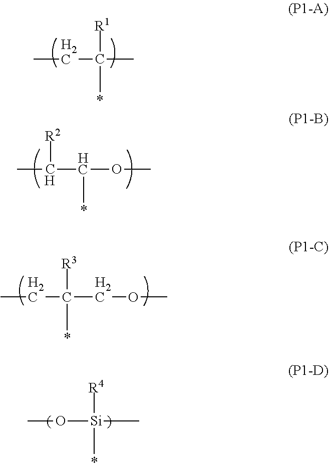

In Formulae (P1-A) to (P1-D), “*” represents a bonding position to L1 Formula (1).

In Formulae (P1-A) to (P1-D), R¹, R², R³, and R⁴ each independently represent a hydrogen atom, a halogen atom, a cyano group, an alkygroup having 1 to 10 carbon atoms, or an alkoxy group having 1 to 10 carbon atoms. The above-described alkygroup may be a linear or branched alkygroup, or an alkygroup having a cyclic structure (cycloalky group). In addition, the number of carbon atoms in the above-described alkygroup is preferably 1 to 5.

It is preferable that the group represented by Formula (P1-A) is one unit of a partial structure of poly(meth)acrylic acid ester, which is obtained by polymerization of (meth)acrylic acid ester.

It is preferable that the group represented by Formula (P1-B) is an ethylene glycol unit formed by ring-opening polymerization of an epoxy group of a compound having the epoxy group.

It is preferable that the group represented by Formula (P1-C) is a propylene glycol unit formed by ring-opening polymerization of an oxetane group of a compound having the oxetane group.

It is preferable that the group represented by Formula (P1-D) is a siloxane unit of a polysiloxane obtained by polycondensation of a compound having at least one of an alkoxysilyl group or a silanol group. Here, examples of the compound having at least one of an alkoxysilyl group or a silanol group include a compound having a group represented by Formula SiR¹⁴(OR¹⁵)₂—. In the formula, R¹⁴ has the same definition as that for R¹⁴ in Formula (P1-D), and a plurality of R¹⁵'s each independently represent a hydrogen atom or an alkygroup having 1 to 10 carbon atoms.

In Formula (1), L1 represents a single bond or a divalent linking group.

Examples of the divalent linking group represented by L1 include —C(O)O—, —O—, —S—, —C(O)NR³—, —SO₂—, and —NR³R⁴—. In the formulae, R³ and R⁴ each independently represent a hydrogen atom or an alkygroup having 1 to 6 carbon atoms, which may have a substituent.

In a case where P1 is a group represented by Formula (P1-A), from the viewpoint of further increasing the alignment degree of the light absorption anisotropic film, it is preferable that L1 is a group represented by —C(O)O—.

In a case where P1 is a group represented by any one of Formulae (P1-B) to (P1-D), from the viewpoint of further increasing the alignment degree of the light absorption anisotropic film, it is preferable that Lis a single bond.

In Formula (1), from the viewpoint of easily expressing liquid crystallinity and availability of raw materials, it is preferable that the spacer group represented by SP1 has at least one structure selected from the group consisting of an oxyethylene structure, an oxypropylene structure, a polysiloxane structure, and an alkylene fluoride structure.

Here, the oxyethylene structure represented by SP1 is preferably a group represented by *—(CH₂—CH₂O)ₙ₁—* is preferable. In the formula, n1 represents an integer of 1 to 20, and * represents a bonding position to L1 or M1 in Formula (1). From the viewpoint of further increasing the alignment degree of the light absorption anisotropic film, n1 is preferably an integer of 2 to 10, more preferably an integer of 2 to 4, and still more preferably 3.

In addition, from the viewpoint of further increasing the alignment degree of the light absorption anisotropic film, the oxypropylene structure represented by SP1 is preferably a group represented by *—(CH(CH₃)—CH₂O)ₙ₂—*. In the formula, n2 represents an integer of 1 to 3, and * represents a bonding position to L1 or M1.

In addition, from the viewpoint of further increasing the alignment degree of the light absorption anisotropic film, the polysiloxane structure represented by SP1 is preferably a group represented by *—(Si(CH₃)₂—O)ₙ₃—*. In the formula, n3 represents an integer of 6 to 10, and * represents a bonding position to L1 or M1.

In addition, from the viewpoint of further increasing the alignment degree of the light absorption anisotropic film, the alkylene fluoride structure represented by SP1 is preferably a group represented by *—(CF₂—CF₂)ₙ₄—*. In the formula, n4 represents an integer of 6 to 10, and * represents a bonding position to L1 or M1.

The mesogen group represented by M1 in Formula (1) is a group representing a main skeleton of a liquid crystal molecule which contributes to liquid crystal formation. A liquid crystal molecule exhibits liquid crystallinity which is in an intermediate state (mesophase) between a crystal state and an isotropic liquid state. The mesogen group is not particularly limited, and for example, descriptions particularly on pages 7 to 16 of “Flussige Kristalle in Tabellen II” (VEB Deutsche Verlag fur Grundstoff Industrie, Leipzig, 1984) and descriptions particularly in Chapter 3 of “Liquid Crystal Handbook” (Maruzen, 2000) edited by Liquid Crystals Handbook Editing Committee can be referred to.

As the mesogen group, for example, a group having at least one cyclic structure selected from the group consisting of an aromatic hydrocarbon group, a heterocyclic group, and an alicyclic group is preferable.

From the viewpoint of further increasing the alignment degree of the light absorption anisotropic film, the mesogen group preferably has an aromatic hydrocarbon group, more preferably has two to four aromatic hydrocarbon groups, and still more preferably has three aromatic hydrocarbon groups.

As the mesogen group, from the viewpoint of exhibiting the liquid crystallinity, of adjusting the liquid crystal phase transition temperature, of availability of raw materials, and of synthetic suitability, and from the viewpoint of further increasing the alignment degree of the light absorption anisotropic film, a group represented by Formula (M1-A) or Formula (M1-B) is preferable, and a group represented by Formula (M1-B) is more preferable.

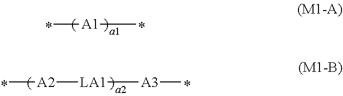

In Formula (M1-A), A1 represents a divalent group selected from the group consisting of an aromatic hydrocarbon group, a heterocyclic group, and an alicyclic group. These groups may be substituted with an alkygroup, a fluorinated alkygroup, an alkoxy group, or a substituent.

It is preferable that the divalent group represented by A1 is a 4- to 6-membered ring. In addition, the divalent group represented by A1 may be a monocyclic ring or a fused ring.

* represents a bonding position to SP1 or T1.

Examples of the divalent aromatic hydrocarbon group represented by A1 include a phenylene group, a naphthylene group, a fluorene-diyl group, an anthracene-diyl group, and a tetracene-diyl group. From the viewpoint of design diversity of the mesogenic skeleton and the availability of raw materials, a phenylene group or a naphthylene group is preferable and a phenylene group is more preferable.

The divalent heterocyclic group represented by A1 may be any of aromatic or non-aromatic, but from the viewpoint of further improving the alignment degree, a divalent aromatic heterocyclic group is preferable.

Examples of atoms other than carbon, constituting the divalent aromatic heterocyclic group, include a nitrogen atom, a sulfur atom, and an oxygen atom. In a case where the aromatic heterocyclic group has a plurality of atoms other than carbon, constituting a ring, these atoms may be the same or different from each other.

Specific examples of the divalent aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, and a thienooxazole-diyl group.

Specific examples of the divalent alicyclic group represented by A1 include a cyclopentylene group and a cyclohexylene group.

In Formula (M1-A), a1 represents an integer of 1 to 10. In a case where a1 represents 2 or more, a plurality of A1's may be the same or different from each other.

In Formula (M1-B), A2 and A3 each independently represent a divalent group selected from the group consisting of an aromatic hydrocarbon group, a heterocyclic group, and an alicyclic group. Specific examples and suitable aspects of A2 and A3 are the same as those for A1 in Formula (M1-A), and thus the description thereof will not be repeated.

In Formula (M1-B), a2 represents an integer of 1 to 10, and in a case where a2 is 2 or more, a plurality of A2's may be the same or different from each other, a plurality of A3's may be the same or different from each other, and a plurality of LA1's may be the same or different from each other. From the viewpoint of further increasing the alignment degree of the light absorption anisotropic film, a2 is preferably an integer of 2 or more and more preferably 2.

In Formula (M1-B), in a case where a2 is 1, LA1 represents a divalent linking group. In a case where a2 is 2 or more, a plurality of LA1's each independently represent a single bond or a divalent linking group, and at least one of the plurality of LA1's is a divalent linking group. In a case where a2 is 2, from the viewpoint of further increasing the alignment degree of the light absorption anisotropic film, it is preferable that one of two LA1's is a divalent linking group and the other is a single bond.

In Formula (M1-B), examples of the divalent linking group represented by LA1 include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —C(Z)₂—C(Z′)₂—, —C(O)—, —OC(O)—, —O—C(O)O—, —N(Z)C(O)—, —C(Z)═C(Z′)—C(O)O—, —C(Z)═N—, —C(Z)═C(Z′)—C(O)N(Z″)—, —C(Z)=C(Z′)—C(O)—S—, —C(Z)═N—N═C(Z′)—(Z, Z′, and Z″ each independently represent a hydrogen atom, a C1 to C4 alkygroup, a cycloalkyl group, an aryl group, a cyano group, or a halogen atom), —C≡C—, —N═N—, —S—, —S(O)—, —S(O)(O)—, —(O)S(O)O—, —O(O)S(O)O—, and —SC(O). Among these, from the viewpoint of further increasing the alignment degree of the light absorption anisotropic film, —C(O)O— is preferable. LA1 may be a group obtained by combining two or more of these groups.

In Formula (1), examples of the terminal group represented by T1 include a hydrogen atom, a halogen atom, a cyano group, a nitro group, a hydroxy group, an alkygroup having 1 to 10 carbon atoms, an alkoxy group having 1 to 10 carbon atoms, an alkylthio group having 1 to 10 carbon atoms, an alkoxycarbonyloxy group having 1 to 10 carbon atoms, an alkoxycarbonyl group having 1 to 10 carbon atoms (ROC(O)—; R represents an alkygroup), an acyloxy group having 1 to 10 carbon atoms, an acylamino group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a (meth)acryloyloxy group-containing group. Examples of the above-described (meth)acryloyloxy group-containing group include a group represented by —L—A (L represents a single bond or a linking group; specific examples of the linking group are the same as those for L1 and SP1 described above; and A represents a (meth)acryloyloxy group).

From the viewpoint of further increasing the alignment degree of the light absorption anisotropic film, T1 is preferably an alkoxy group having 1 to 10 carbon atoms, more preferably an alkoxy group having 1 to 5 carbon atoms, and still more preferably a methoxy group.

These terminal groups may be further substituted with the groups or polymerizable groups described in JP2010-244038A.

From the viewpoint of further enhancing the adhesiveness of the film to the adjacent layer and improving cohesive force of the film, it is preferable that T1 is a polymerizable group.

The polymerizable group is not particularly limited, and is preferably a polymerizable group capable of radical polymerization or cationic polymerization.

A known polymerizable group can be used as the radically polymerizable group, and suitable examples thereof include an acryloyl group and a methacryloyl group. In this case, it is known that an acryloyl group has a higher polymerization rate, and from the viewpoint of improving productivity, an acryloyl group is preferable. However, a methacryloyl group can also be used as the polymerizable group.

A known cationically polymerizable group can be used as the cationically polymerizable group, and examples thereof include an alicyclic ether group, a cyclic acetal group, a cyclic lactone group, a cyclic thioether group, a spiroorthoester group, and a vinyloxy group. Among these, an alicyclic ether group or a vinyloxy group is suitable, and an epoxy group, an oxetanyl group, or a vinyloxy group is preferable.

From the viewpoint of further increasing the alignment degree of the light absorption anisotropic film, a weight-average molecular weight (Mw) of the high-molecular-weight liquid crystal compound having a repeating unit represented by Formula (1) is preferably 1,000 to 500,000 and more preferably 2,000 to 300,000. In a case where the Mw of the high-molecular-weight liquid crystal compound is within the above-described range, the high-molecular-weight liquid crystal compound is easily handled.

In particular, from the viewpoint of suppressing cracking during coating, the weight-average molecular weight (Mw) of the high-molecular-weight liquid crystal compound is preferably 10,000 or more and more preferably 10,000 to 300,000.

In addition, from the viewpoint of temperature latitude of the alignment degree, the weight-average molecular weight (Mw) of the high-molecular-weight liquid crystal compound is preferably less than 10,000 and more preferably 2,000 or more and less than 10,000.

Here, the weight-average molecular weight and the number-average molecular weight in the present specification are values measured by a gel permeation chromatography (GPC) method.
Solvent (eluent): N-methylpyrrolidone
Device name: TOSOH HLC-8220GPC
Column: using three columns of TOSOH TSKgel Super AWM-H (6 mm×15 cm) connected
Column temperature: 25° C.
Sample concentration: 0.1% by mass
Flow rate: 0.35 mL/min
Calibration curve: TSK standard polystyrene (manufactured by TOSOH Corporation), calibration curves of 7 samples with Mw of 2,800,000 to 1,050 (Mw/Mn=1.03 to 1.06) are used.

The liquid crystal compounds may be used alone or in combination of two or more kinds thereof. The present light absorption anisotropic film preferably contains two or more kinds of liquid crystal compounds.

From the viewpoint that the effect of the present invention is more excellent, a content of the liquid crystal compound in the present light absorption anisotropic film is preferably 50% to 99% by mass and more preferably 75% to 90% by mass with respect to the total mass of the light absorption anisotropic film.

### Other Components

The light absorption anisotropic film may contain other components in addition to the components described above. Examples of the other components include an interface improver, a vertical alignment agent, and a leveling agent.

### Interface Improver

The interface improver contained in the light absorption anisotropic film is not particularly limited, and a known high-molecular-weight-based interface improver and low-molecular-weight-based interface improver can be used.

As the interface improver, compounds described in paragraphs [0253] to [0293] of JP2011-237513A can be used.

In addition, fluorine (meth)acrylate-based polymers described in paragraphs [0018] to [0043] of JP2007-272185A can also be used as the interface improver.

In addition, examples of the interface improver include compounds described in paragraphs [0079] to [0102] of JP2007-069471A, polymerizable liquid crystalline compounds represented by Formula (4) described in JP2013-047204A (particularly, compounds described in paragraphs [0020] to [0032]), polymerizable liquid crystalline compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0092] to [0096]) and paragraphs [0082] to [0084]), compounds represented by Formulae (4), (II), and (III) described in JP2005-099248A (particularly, compounds described in paragraphs [0092] to [0096]), compounds described in paragraphs [0013] to [0059] of JP4385997B, compounds described in paragraphs [0018] to [0044] of JP5034200B, and compounds described in paragraphs [0019] to [0038] of JP4895088B.

The interface improvers may be used alone or in combination of two or more kinds thereof.

In a case where the light absorption anisotropic film contains an interface improver, a content of the interface improver is preferably 0.001 to 5 parts by mass with respect to 100 parts by mass of the total of the above-described dichroic substance and the above-described liquid crystalline compound. In a case where a plurality of interface improvers are used in combination, it is preferable that the total amount of the plurality of interface improvers is within the above-described range.

### Vertical Alignment Agent

Examples of the vertical alignment agent include a boronic acid compound and an onium salt.

The boronic acid compound is preferably a compound represented by Formula (A).

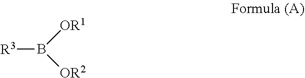

In Formula (A), R¹ and R² each independently represent a hydrogen atom, a substituted or unsubstituted aliphatic hydrocarbon group, a substituted or unsubstituted aryl group, or a substituted or unsubstituted heterocyclic group.

R³ represents a substituent including a (meth)acryl group.

Specific examples of the boronic acid compound include a boronic acid compound represented by General Formula (I), described in paragraphs [0023] to [0032] of JP2008-225281A.

As the boronic acid compound, compounds shown below are also preferable.

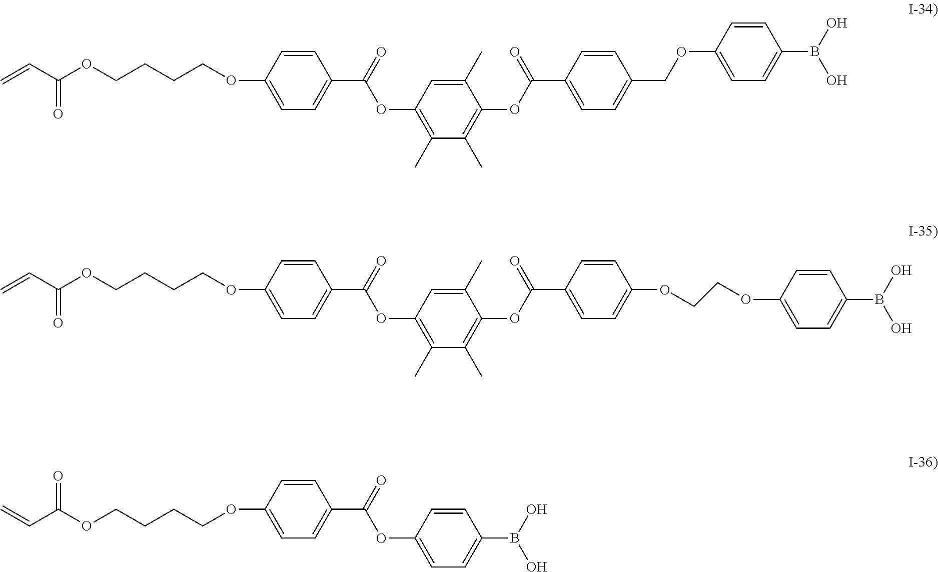 [SMILES: C=CC(=O)OCCCCOc1ccc(C(=O)Oc2cc(C)c(OC(=O)c3ccc(COc4ccc(B(O)O)cc4)cc3)c(C)c2C)cc1 ; C=CC(=O)OCCCCOc1ccc(C(=O)Oc2cc(C)c(OC(=O)c3ccc(OCCOc4ccc(B(O)O)cc4)cc3)c(C)c2C)cc1 ; C=CC(=O)OCCCCOc1ccc(C(=O)Oc2ccc(B(O)O)cc2)cc1]

The onium salt is preferably a compound represented by Formula (B).

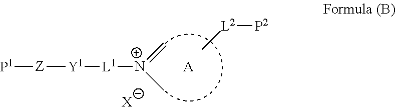

In Formula (B), a ring A represents a quaternary ammonium ion consisting of a nitrogen-containing heterocyclic ring. X⁻ represents an anion. L¹ represents a divalent linking group. L² represents a single bond or a divalent linking group. Y¹ represents a divalent linking group having a 5- or 6-membered ring as a partial structure. Z represents a divalent linking group having an alkylene group having 2 to 20 as a partial structure. P¹ and P² each independently represent a monovalent substituent having a polymerizable ethylenically unsaturated bond.

Specific examples of the onium salt include onium salts described in paragraphs [0052] to [0058] of JP2012-208397A, onium salts described in paragraphs [0024] to [0055] of JP2008-026730A, and onium salts described in JP2002-037777A.

In a case where the light absorption anisotropic film contains the liquid crystal compound and a vertical alignment agent, a content of the vertical alignment agent is preferably 0.1% to 400% by mass and more preferably 0.5% to 350% by mass with respect to the total mass of the liquid crystal compound.

The vertical alignment agent may be used alone or in combination of two or more kinds thereof. In a case where two or more kinds of vertical alignment agents are used, the total amount thereof is preferably within the above-described range.

### Leveling Agent

The light absorption anisotropic film may contain a leveling agent. In a case where the composition for forming a light absorption anisotropic film (light absorption anisotropic film) described later contains the leveling agent, surface roughness due to dry air applied to the surface of the light absorption anisotropic film is suppressed, and the dichroic substance is more uniformly aligned.

The leveling agent is not particularly limited, and a leveling agent having a fluorine atom (fluorine-based leveling agent) or a leveling agent having a silicon atom (silicon-based leveling agent) is preferable, and a fluorine-based leveling agent is more preferable.

Examples of the fluorine-based leveling agent include fatty acid esters of polyvalent carboxylic acid, in which a part of a fatty acid is substituted with a fluoroalkyl group, and polyacrylates having a fluoro substituent.

Specific examples of the leveling agent also include compounds described in paragraphs [0046] to [0052] of JP2004-331812A and compounds described in paragraphs [0038] to [0052] of JP2008-257205A.

In a case where the light absorption anisotropic film contains the liquid crystal compound and a leveling agent, a content of the leveling agent is preferably 0.001% to 10% by mass and more preferably 0.01% to 5% by mass with respect to the total mass of the liquid crystal compound.

The leveling agent may be used alone or in combination of two or more kinds thereof. In a case where two or more kinds of leveling agents are used, the total amount thereof is preferably within the above-described range.

### Composition for Forming Light Absorption Anisotropic Film

It is preferable that the light absorption anisotropic film is formed of a composition for forming a light absorption anisotropic film, which contains a dichroic substance and a liquid crystal compound.

It is preferable that the composition for forming a light absorption anisotropic film contains a solvent described later in addition to the dichroic substance and the liquid crystal compound. The composition for forming a light absorption anisotropic film may further contain other components.

Examples of the other components include the above-described interface improver, the above-described vertical alignment agent, the above-described leveling agent, a polymerization initiator described later, and a polymerizable component described later.

Examples of the dichroic substance contained in the composition for forming a light absorption anisotropic film include the dichroic substance contained in the light absorption anisotropic film.

It is preferable that a content of the dichroic substance with respect to the total solid content mass of the composition for forming a light absorption anisotropic film is the same as the content of the dichroic substance with respect to the total mass of the light absorption anisotropic film.

Here, the “total solid content in the composition for forming a light absorption anisotropic film” denotes components excluding a solvent. Specific examples of the solid content include the dichroic substance, the liquid crystal compound, and the above-described other components.

The liquid crystal compound, the interface improver, the vertical alignment agent, and the leveling agent contained in the composition for forming a light absorption anisotropic film are the same as the liquid crystal compound, the interface improver, the vertical alignment agent, and the leveling agent contained in the light absorption anisotropic film, respectively.

It is preferable that each content of the liquid crystal compound, the interface improver, the vertical alignment agent, and the leveling agent with respect to the total solid content mass of the composition for forming a light absorption anisotropic film is the same as each content of the liquid crystal compound, the interface improver, the vertical alignment agent, and the leveling agent with respect to the total mass of the light absorption anisotropic film.

From the viewpoint of the workability, it is preferable that the composition for forming a light absorption anisotropic film contains a solvent.

Examples of the solvent include organic solvents such as ketones, ethers, aliphatic hydrocarbons, alicyclic hydrocarbons, aromatic hydrocarbons, carbon halides, esters, alcohols, cellosolves, cellosolve acetates, sulfoxides, amides, and heterocyclic compounds, and water.

These solvents may be used alone or in combination of two or more kinds thereof.

Among these solvents, organic solvents are preferable, and carbon halides or ketones are more preferable.

In a case where the composition for forming a light absorption anisotropic film contains a solvent, a content of the solvent is preferably 80% to 99% by mass, more preferably 83% to 97% by mass, and still more preferably 85% to 95% by mass with respect to the total mass of the composition for forming a light absorption anisotropic film.

The composition for forming a light absorption anisotropic film may contain a polymerization initiator.

The polymerization initiator is not particularly limited, but a compound having photosensitivity, that is, a photopolymerization initiator is preferable.

Commercially available products can also be used as such a photopolymerization initiator, and examples thereof include IRGACURE (registered trademark) 184, IRGACURE 907, IRGACURE 369, IRGACURE 651, IRGACURE 819, IRGACURE OXE-01, and IRGACURE OXE-02, manufactured by BASF SE.

The polymerization initiator may be used alone or in combination of two or more kinds thereof.

In a case where the composition for forming a light absorption anisotropic film contains a polymerization initiator, a content of the polymerization initiator is preferably 0.01% to 30% by mass and more preferably 0.1% to 15% by mass with respect to the total solid content of the composition for forming a light absorption anisotropic film.

The composition for forming a light absorption anisotropic film may contain a polymerizable component.

Examples of the polymerizable component include a compound including an acrylate (such as an acrylate monomer). In a case of using a compound including an acrylate, the light absorption anisotropic film includes a polyacrylate obtained by polymerizing the compound including an acrylate.

In addition, examples of the polymerizable component also include compounds described in paragraph of JP2017-122776A.

In a case where the composition for forming a light absorption anisotropic film contains a polymerizable component, a content of the polymerizable component is preferably 3 to 20 parts by mass with respect to 100 parts by mass of the total of the above-described dichroic substance and the above-described liquid crystalline compound in the composition for forming a light absorption anisotropic film.

### Manufacturing Method of Light Absorption Anisotropic Film

A method for manufacturing the light absorption anisotropic film is not particularly limited as long as it is a method capable of forming the light absorption anisotropic film satisfying any of the above-described requirements 1 to 3, in which a plurality of regions with different directions of transmittance central axes are arranged in an in-plane direction, and a known manufacturing method can be adopted.

Examples of the manufacturing method of a light absorption anisotropic film include a method including, in the following order, a step of forming an alignment film (hereinafter, also referred to as “specific alignment film”) having a plurality of regions with different directions of alignment regulating force in an in-plane direction (hereinafter, also referred to as “specific alignment film forming step”), a step of applying the above-described composition for forming a light absorption anisotropic film onto the obtained specific alignment film to form a coating film (hereinafter, also referred to as “coating film forming step”), and a step of aligning liquid crystalline components contained in the coating film (hereinafter, also referred to as “alignment step”).

The liquid crystalline component is a component which includes not only the above-described liquid crystal compound but also a dichroic substance having liquid crystallinity.

Hereinafter, the manufacturing method of a light absorption anisotropic film will be described with the method including the specific alignment film forming step, the coating film forming step, and the alignment step described above as an example, but the manufacturing method of a light absorption anisotropic film is not limited to the following method.

### Specific Alignment Film Forming Step

The specific alignment film forming step is a step of forming the specific alignment film that has alignment regulating force for aligning the liquid crystalline components which can be contained in the composition for forming a light absorption anisotropic film, in which a plurality of regions with different directions of the alignment regulating force are arranged in-plane.

Examples of the method of forming the specific alignment film include a rubbing treatment on a film surface of an organic compound (preferably, a polymer), forming a layer having microgrooves, applying an electric field, applying a magnetic field, and applying an orientation function by light irradiation.

As the specific alignment film forming step, from the viewpoint of easily controlling a pretilt angle of the alignment film, it is preferable to form the alignment film by a rubbing treatment, and from the viewpoint of uniformity of alignment and ease of forming the plurality of regions with different directions of the alignment regulating force, it is preferable to form a photo-alignment film by light irradiation and it is more preferable to form a photo-alignment film.

The photo-alignment film formed by light irradiation is not particularly limited as long as it is an alignment film to which the alignment regulating force in a predetermined direction is applied. A material for forming the photo-alignment film is not particularly limited, and the photo-alignment film is formed of, for example, a composition for forming an alignment film, which contains a photo-alignment agent.

The photo-alignment agent is a compound having a photo-aligned group, and is not particularly limited as long as it is a material to which the alignment regulating force is applied by an alignment treatment described later.

Examples of the photo-aligned group include a group having a photo-alignment function which induces rearrangement or an anisotropic chemical reaction upon irradiation of light having anisotropy (for example, plane-polarized light). That is, the photo-aligned group is a group which can undergo at least one photo-reaction selected from a photoisomerization reaction, a photodimerization reaction, or a photodegradation reaction by irradiation with light (for example, linearly polarized light), and change its molecular structure. Among these, from the viewpoint that it has excellent uniformity of alignment and favorable thermal and chemical stability, a group which causes a photoisomerization reaction (a group having a photoisomerization structure) or a group which causes a photodimerization reaction (a group having a photodimerization structure) is preferable.

The photoisomerization reaction is a reaction which causes stereoisomerization or structural isomerization due to action of light. Examples of a photo-alignment agent having the group which causes a photoisomerization reaction include substances having an azobenzene structure (K. Ichimura et al., Mol. Cryst. Liq. Cryst., 298, page 221 (1997)), substances having a hydrazono-β-ketoester structure (S. Yamamura et al., Liquid Crystals, vol. 13, No. 2, page 189 (1993)), substances having a stilbene structure (J. G. Victor and J. M. Torkelson, Macromolecules, 20, page 2241 (1987)), and groups having a cinnamic acid (cinnamoyl) structure (skeleton) and substances having a spiropyran structure (K. Ichimura et al., Chemistry Letters, page 1063 (1992); K. Ichimura et al., Thin Solid Films, vol. 235, page 101 (1993)).

As the group which causes a photoisomerization reaction, a group which causes a photoisomerization reaction, having a C═C bond or an N═N bond, is preferable, and examples of such a group include a group having an azobenzene structure (skeleton), a group having a hydrazono-β-ketoester structure (skeleton), a group having a stilbene structure (skeleton), a group having a cinnamic acid (cinnamoyl) structure (skeleton), and a group having a spiropyran structure (skeleton). Among these, a group having an azobenzene structure, a group having a cinnamoyl structure, or a group having a coumarin structure is preferable, and a group having an azobenzene structure or a group having a cinnamoyl structure is more preferable.

The photodimerization reaction is a reaction in which a ring structure is typically formed by occurrence of an addition reaction between two groups due to action of light. Examples of a photo-alignment agent having the group which causes photodimerization include substances having a cinnamic acid structure (M. Schadt et al., J. Appl. Phys., vol. 31, No. 7, page 2155 (1992)), substances having a coumarin structure (M. Schadt et al., Nature., vol. 381, page 212 (1996)), substances having a chalcone structure (Toshihiro Ogawa et al., Preprints of symposium on liquid crystals, 2AB03 (1997)), and substances having a benzophenone structure (Y. K. Jang et al., SID Int. Symposium Digest, P-53 (1997)).

Examples of the group which causes a photodimerization reaction include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these, a group having a cinnamoyl structure or a group having a coumarin structure is preferable, and a group having a cinnamoyl structure is more preferable.

It is preferable that the photo-alignment agent further has a crosslinkable group.

As the crosslinkable group, a thermally crosslinking group which causes a curing reaction due to action of heat or a photo-crosslinkable group which causes a curing reaction due to action of light is preferable, and the crosslinkable group may be a crosslinkable group which has both the thermally crosslinking group and the photo-crosslinkable group. More specific examples of the crosslinkable group include a hydroxyl group, a carboxyl group, an amino group, a radically polymerizable group (for example, an acryloyl group, a methacryloyl group, a vinyl group, a styryl group, and an allyl group), and a cationically polymerizable group (for example, an epoxy group, an epoxycyclohexyl group, and an oxetanyl group).

As the photo-alignment agent, a polymer having the photo-aligned group can also be preferably used, and from the viewpoint of achieving adhesion between the photo-alignment film and the light absorption anisotropic film, a polymer having the photo-aligned group, which has hydrophobicity close to that of the light absorption anisotropic film, is more preferable.

Examples of the polymer having the photo-aligned group include photo-alignable acrylate polymers described in JP1994-289374A (JP-H6-289374A), JP1998-506420A (JP-H10-305036A), JP2009-501238A, JP2012-078421A, JP2015-106062A, JP2016-079189A, and the like; photo-alignable polysiloxanes described in JP2012-037868A, JP2014-026261A, JP2015-026050A, and the like; photo-alignable polystyrene-acrylate copolymers described in JP2015-151548A, JP2015-151549A, JP2016-098249A, and the like; and photo-alignable polynorbornene polymers described in JP2012-027471A, JP2015-533883A, and the like.

A content of the photo-alignment agent in the composition for forming a photo-alignment film is not particularly limited, but is preferably 0.1 to 50 parts by mass and more preferably 0.5 to 10 parts by mass with respect to 100 parts by mass of the solvent described below.

From the viewpoint of workability for producing the photo-alignment film, it is preferable that the composition for forming a photo-alignment film contains a solvent. Examples of the solvent include water and an organic solvent. Examples of the organic solvent include the organic solvents which may be contained in the above-described composition for forming a light absorption anisotropic layer.

The solvents may be used alone or in combination of two or more kinds thereof.

The composition for forming a photo-alignment film may contain other components in addition to the above-described components. Examples of the other components include an acid generator, a crosslinking catalyst, an adhesion improver, a leveling agent, a surfactant, and a plasticizer.

Hereinafter, the method of forming the specific alignment film by light irradiation will be described with reference to the accompanying drawings.

The method of forming the specific alignment film by light irradiation is not particularly limited, and examples thereof include a method including an applying treatment in which the above-described composition for forming a photo-alignment film is applied onto a surface of a base material to form a coating film and a photo alignment treatment in which the formed coating film is irradiated with polarized or non-polarized light to form the specific alignment film.

### Applying Treatment

The applying treatment is a step of applying the composition for forming a photo-alignment film onto the surface of the base material to form a coating film.

The method of applying the composition for forming a photo-alignment film is not limited, and examples thereof include a roll coating method, a gravure printing method, a spin coating method, a wire bar coating method, an extrusion coating method, a direct gravure coating method, a reverse gravure coating method, a die coating method, a spraying method, and an ink jet method.

Examples of the base material to be coated with the composition for forming a photo-alignment film in the applying treatment include a transparent resin film described later.

### Photo Alignment Treatment

The specific alignment film is formed by performing a photo alignment treatment of irradiating the coating film formed by the applying treatment with polarized or non-polarized light.

Various light sources such as infrared rays, visible light, and ultraviolet rays can be used as a light source for the photo alignment treatment, but ultraviolet rays are preferable.

In a case where the coating film is irradiated with polarized light in the photo alignment treatment, an irradiation direction may be a normal direction of the surface of the coating film, or may be an oblique direction with respect to the surface of the coating film. In a case where the coating film is irradiated with non-polarized light in the photo alignment treatment, an irradiation direction is an oblique direction with respect to the surface of the coating film.

The photo alignment treatment is a treatment of forming an alignment film having the plurality of regions with different directions of the alignment regulating force by irradiating the above-described coating film with polarized or non-polarized light with different incident directions with respect to the coating film depending on the in-plane position.

In the photo alignment treatment, it is preferable to use polarized light, and it is more preferable to use polarized ultraviolet rays.

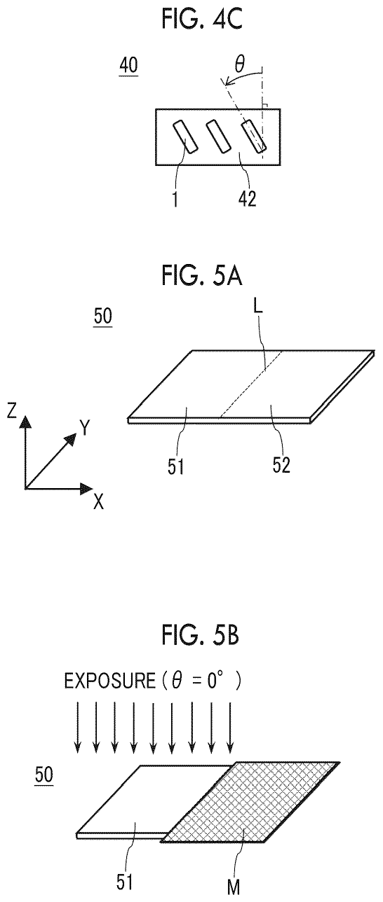

The photo alignment treatment will be described in more detail with reference to FIGS. 5A, 5B, and 5C (hereinafter, collectively referred to as “FIG. 5”).

FIG. 5 is a conceptual view showing one embodiment of the photo alignment treatment performed on the coating film of the composition for forming an alignment film. The X-axis, Y-axis, Z-axis, angle θ, and angle φ shown in FIGS. 5 to 7 are as described above in the description of FIG. 1.

FIG. 5 is a perspective view of obliquely observing a coating film 50 of the composition for forming an alignment film, which has been formed in the above-described applying treatment, from above. In addition, the coating film 50 is formed on the surface of the base material (not shown). As shown in FIG. 5A, the coating film 50 is divided into two regions of a first region 51 on a negative direction side of the X-axis (on the left side of the paper plane) and a second region 52 on a positive direction side of the X-axis (on the right side of the paper plane) by a boundary line L which is equidistant from both ends in the X-axis direction.

As the photo alignment treatment, first, as shown in FIG. 5B, a mask M is disposed to cover an upper side of the second region 52 of the coating film 50, so that only the second region 52 is shielded from light and the first region 51 is exposed. The exposed first region 51 is irradiated with polarized light in a first direction. In FIG. 5B, the first direction is a positive direction of the Z-axis (direction of the angle θ =) 0°.

Next, as shown in FIG. 5C, by moving the mask M to a position which covers an upper side of the first region 51, only the first region 51 is shielded from light and the second region 52 is exposed. The exposed second region 52 is irradiated with polarized light in a second direction. In FIG. 5C, the second direction is a direction inclined by 35° from the positive direction of the Z-axis toward the negative direction of the X-axis (direction of the angle θ =35° and the angle φ=0°.

After irradiating the second region 52, the mask M is removed to form the specific alignment film having different directions of the alignment regulating force in the first region 51 and the second region 52.

The light absorption anisotropic film 10 shown in FIG. 1 is obtained by performing the coating film forming step and the alignment step on the specific alignment film formed by the above-described photo alignment treatment.

In the photo alignment treatment shown in FIG. 5, the coating film 50 is divided into two equal regions in the X-axis direction, and each of the two regions is irradiated with light from different incident directions, but the photo alignment treatment is not limited to this aspect. The coating film may be divided into three or more regions in-plane, and each region may be irradiated with light from different incident directions.

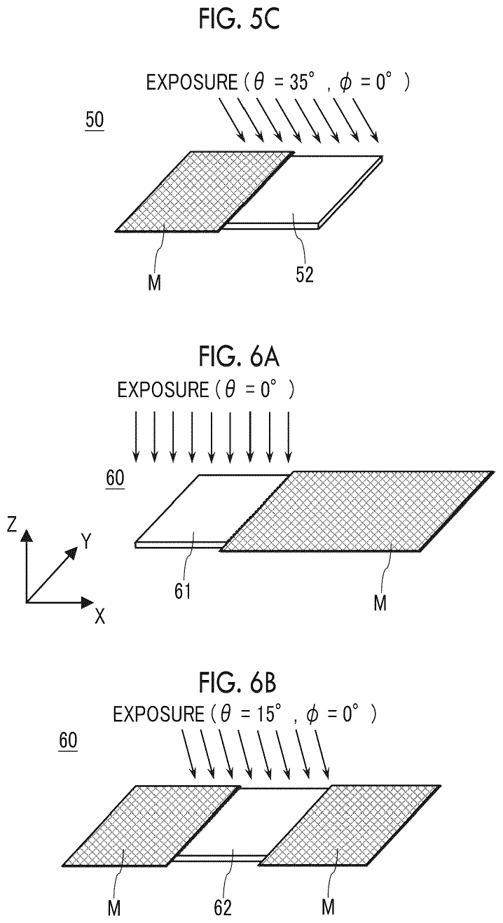

FIGS. 6A, 6B, and 6C (hereinafter, collectively referred to as “FIG. 6”) are conceptual views showing another example of the photo alignment treatment.

FIG. 6 is a perspective view of obliquely observing a coating film 60 of the composition for forming an alignment film, which has been formed in the above-described applying treatment, from above. In addition, the coating film 60 is formed on the surface of the base material (not shown). The coating film 60 shown in FIG. 6 is divided into three regions of a first region 61, a second region 62, and a third region 63 from the negative direction side of the X-axis in the X-axis direction.

As the photo alignment treatment, first, as shown in FIG. 6A, a mask M is disposed to cover upper sides of the second region 62 and the third region 63 of the coating film 60, so that the second region 62 and the third region 63 are shielded from light and the first region 61 is exposed. The exposed first region 61 is irradiated with polarized light in a first direction. In FIG. 6A, the first direction is a positive direction of the Z-axis (direction of the angle θ=0°).

Next, as shown in FIG. 6B, by disposing two masks M to positions which cover an upper side of the first region 61 and an upper side of the third region 63, the first region 61 and the third region 63 are shielded from light and the second region 62 is exposed. The exposed second region 62 is irradiated with polarized light in a second direction. In FIG. 6B, the second direction is a direction inclined by 15° from the positive direction of the Z-axis toward the negative direction of the X-axis (direction of the angle θ=15° and the angle φ=0°).

Next, as shown in FIG. 6C, by disposing the mask M to a position which covers upper side of the first region 61 and the second region 62, the first region 61 and the second region 62 are shielded from light and the third region 63 is exposed. The exposed third region 63 is irradiated with polarized light in a third direction. In FIG. 6C, the third direction is a direction inclined by 35° from the positive direction of the Z-axis toward the negative direction of the X-axis (direction of the angle θ=35° and the angle φ=0°).

After irradiating the third region 63, the mask M is removed to form the specific alignment film having different directions of the alignment regulating force in the first region 61, the second region 62, and the third region 63.

The light absorption anisotropic film 20 shown in FIG. 2 is obtained by performing the coating film forming step and the alignment step on the specific alignment film formed by the above-described photo alignment treatment.

The photo alignment treatment is not limited to the method of forming the specific alignment film in which the direction of the alignment regulating force as described above changes in a stepwise manner depending on the position in-plane, and may be a method of forming the specific alignment film in which the direction of the alignment regulating force changes in a continuous manner.

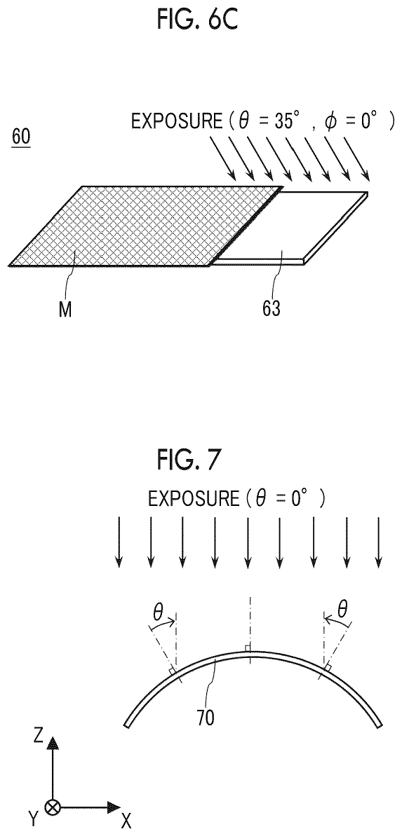

Still another embodiment of the photo alignment treatment will be described with reference to FIG. 7. FIG. 7 is a conceptual view showing still another embodiment of the photo alignment treatment, and is a front view of observing a coating film 70 of the composition for forming an alignment film, which has been formed in the above-described applying treatment, from the negative direction of the Y-axis. The coating film 70 is formed on the surface of the base material (not shown).

As shown in FIG. 7, the coating film 70 is bent in an inverted U shape. As described above, the coating film 70 having a convex surface on the side of the positive direction of the Z-axis (direction of the angle θ=0° is irradiated with polarized light from the positive direction of the Z-axis. As a result, the incidence angle of the polarized light with respect to the curved surface of the coating film 70 changes in a continuous manner depending on the position of the coating film 70 in the X-axis direction. After the alignment, the coating film 70 is returned to a planar shape to form the specific alignment film in which the direction of the alignment regulating force (angle θ) changes in a continuous manner along the X-axis direction.

The light absorption anisotropic film 30 shown in FIG. 3 is obtained by performing the coating film forming step and the alignment step on the specific alignment film obtained as described above.

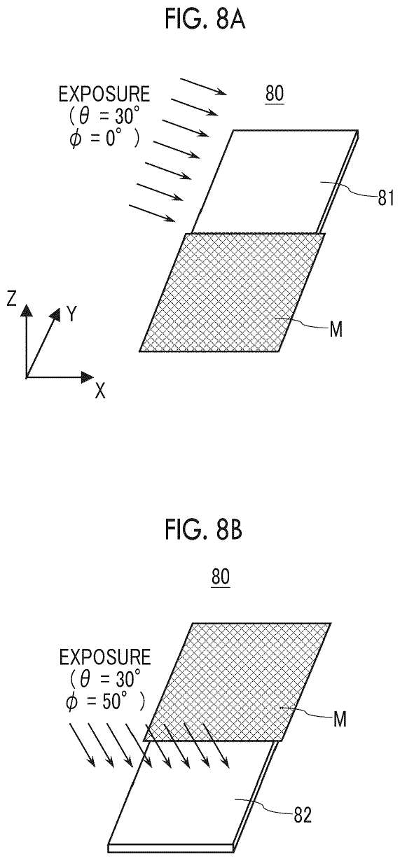

Still another embodiment of the photo alignment treatment will be described in more detail with reference to FIGS. 8A and 8B (hereinafter, collectively referred to as “FIG. 8”). The X-axis, Y-axis, Z-axis, angle θ, and angle φ shown in FIG. 8 are as described above in the description of FIG. 4.

FIG. 8 is a conceptual view showing still another embodiment of the photo alignment treatment, and is a perspective view of obliquely observing a coating film 80 of the composition for forming an alignment film, which has been formed in the above-described applying treatment, from above. In addition, the coating film 80 is formed on the surface of the base material (not shown). The coating film 80 is divided into two regions of a first region 81 on the positive direction side of the Y-axis (on the upper side of the paper plane) and a second region 82 on the negative direction side of the Y-axis (on the lower side of the paper plane) by a boundary line which is equidistant from both ends in the Y-axis direction.

As the photo alignment treatment, first, as shown in FIG. 8A, a mask M is disposed to cover an upper side of the second region 82, so that only the second region 82 is shielded from light and the first region 81 is exposed. The exposed first region 81 is irradiated with polarized light in a first direction. In FIG. 8A, the first direction is a direction inclined by 30° from the positive direction of the Z-axis toward the negative direction of the X-axis (direction of the angle θ=30° and the angle φ=0°) .

Next, as shown in FIG. 8B, by moving the mask M to a position which covers an upper side of the first region 81 of the coating film 80, only the first region 81 is shielded from light and the second region 82 is exposed. The exposed second region 82 is irradiated with polarized light in a second direction. In FIG. 8B, the second direction is a direction inclined by 30° from the positive direction of the Z-axis toward a direction in which the angle φ is 50° on the XY plane (direction of the angle θ=30°).

After irradiating the second region 82, the mask M is removed to form the specific alignment film having different directions of the alignment regulating force in the first region 81 and the second region 82.

The light absorption anisotropic film 40 shown in FIG. 4 is obtained by performing the coating film forming step and the alignment step on the specific alignment film formed by the above-described photo alignment treatment.

The photo alignment treatment is not limited to the above-described embodiments shown in FIGS. 5 to 8, and is appropriately selected depending on the arrangement of the plurality of regions with different directions of the transmittance central axes in the target light absorption anisotropic film.

A thickness of the specific alignment film formed by the specific alignment film forming step is not particularly limited, but is preferably 0.01 to 10 μm and more preferably 0.01 to 1 μm.

### Coating Film Forming Step

The coating film forming step is a step of applying the composition for forming a light absorption anisotropic film onto the surface of the specific alignment film to form a coating film.

In the present step, it is preferable to use a composition for forming a light absorption anisotropic film, containing the above-described solvent, or a liquid material such as a heated molten liquid of the composition for forming a light absorption anisotropic film. As a result, the composition for forming a light absorption anisotropic film is easily applied onto the specific alignment film.

Examples of a method of applying the composition for forming a light absorption anisotropic film include known methods such as a roll coating method, a gravure printing method, a spin coating method, a wire bar coating method, an extrusion coating method, a direct gravure coating method, a reverse gravure coating method, a die coating method, a spraying method, and an ink jet method.

### Alignment Step

The alignment step is a step of aligning a liquid crystalline component (particularly, the dichroic substance) contained in the coating film. In the alignment step, the dichroic substance is considered to be aligned along the liquid crystal compound aligned by the alignment regulating force of the specific alignment film.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

It is preferable that the alignment step includes a heat treatment. As a result, aligning properties of the dichroic substance contained in the coating film are improved, and the alignment degree of the obtained light absorption anisotropic film is further increased.

From the viewpoint of manufacturing suitability, a heat temperature is preferably 10° C. to 250° C. and more preferably 25° C. to 190° C. In addition, a heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). As a result, the alignment of the dichroic substance contained in the coating film is further fixed, and the alignment degree of the light absorption anisotropic film is further increased. A cooling unit is not particularly limited, and the cooling treatment can be performed according to a known method.

The present light absorption anisotropic film can be obtained by performing the above-described steps.

### Other Steps

The manufacturing method of a light absorption anisotropic film may include a step of curing the light absorption anisotropic film after the above-described alignment step (hereinafter, also referred to as “curing step”).

The curing step is performed by, for example, heating the film and/or irradiating (exposing) the film with light. Among these, it is preferable that the curing step is performed by light irradiation.

Examples of a light source which can be used for the curing include various light sources such as infrared rays, visible light, and ultraviolet rays, and ultraviolet rays are preferable. In addition, ultraviolet rays may be applied while the layer is heated during curing, or ultraviolet rays may be applied through a filter which transmits only a specific wavelength.

In addition, the exposure may be performed under a nitrogen atmosphere. In a case where the curing of the light absorption anisotropic film proceeds by radical polymerization, since inhibition of polymerization by oxygen is reduced, it is preferable that the exposure is performed in a nitrogen atmosphere.

### Optical Film

The optical film is a member including at least the light absorption anisotropic film according to the embodiment of the present invention. The optical film is preferably a laminated film in which an alignment film and the light absorption anisotropic film are laminated, and a laminated film in which a transparent base material film, an alignment film, and the light absorption anisotropic film are laminated in this order.

### Transparent Base Material Film

The optical film may include a transparent base material film.

The transparent base material film may be used as a base material for forming the light absorption anisotropic film, or may be used as a film for protecting the light absorption anisotropic film. The transparent base material film may also serve as a retardation layer.

The transparent base material film is not particularly limited, and a known transparent resin film, transparent resin plate, transparent resin sheet, or the like can be used.

Preferred examples of the transparent resin film include a cellulose acylate film (such as a cellulose triacetate film (refractive index of 1.48), a cellulose diacetate film, a cellulose acetate butyrate film, or a cellulose acetate propionate film), a polyethylene terephthalate film, a polyether sulfone film, a polyurethane-based resin film, a polyester film, a polycarbonate film, a polysulfone film, a polyether film, a polymethylpentene film, a polyether ketone film, a (meth)acrylonitrile film, a cycloolefin-based polymer film (polymer film formed of a cycloolefin-based polymer), a polycarbonate-based polymer film, a polystyrene-based polymer film, and an acrylic polymer film.

It is preferable that the acrylic polymer film includes an acrylic polymer having at least one unit selected from a lactone ring unit, a maleic acid anhydride unit, or a glutaric anhydride unit.

A thickness of the transparent base material film is preferably 20 to 100 μm.

### Alignment Film

The optical film may include an alignment film, and it is preferable that the optical film includes the above-described specific alignment film.

Specific aspects of the alignment film are as described above as the specific alignment film.

The optical film may include a layer other than the light absorption anisotropic film, the transparent base material film, and the alignment film, and it is preferable that the optical film further includes a resin film containing polyvinyl alcohol or polyimide. The above-described resin film may be disposed on one surface of the light absorption anisotropic layer, or may be disposed on both surfaces of the light absorption anisotropic layer.

By forming the resin film containing polyvinyl alcohol or polyimide between two layers selected from the group consisting of the light absorption anisotropic film, the transparent base material film, and the alignment film, the resin film functions as a primer layer which improves adhesiveness of the two layers. In addition, the above-described resin film also has a function as a barrier layer described later.

Examples of the polyvinyl alcohol, polyimide contained in the above-described resin film include known polyvinyl alcohol, polyimide, and any derivatives thereof as a polymer material for the alignment film, and modified or unmodified polyvinyl alcohol is preferable.

A thickness of the resin film is not particularly limited, but is preferably 0.01 to 10 μm and more preferably 0.01 to 1 μm.

A method of forming the resin film is not particularly limited, and examples thereof include a method of applying a resin composition containing polyvinyl alcohol or polyimide onto the surface of the light absorption anisotropic layer to form a coating film, and then curing the formed coating film to obtain the resin film. The method of forming the coating film is not particularly limited, and examples thereof include the method described as the applying treatment in the above-described specific alignment film forming step. In addition, examples of the method of curing the coating film include a method of removing the solvent contained in the coating film by heating and/or drying the coating film to form the resin film.

### Viewing Angle Control System

The viewing angle control system includes a polarizer having an absorption axis in an in-plane direction, and the above-described light absorption anisotropic film or the above-described optical film.

In particular, in a case where the present light absorption anisotropic film satisfies the requirement 3, from the viewpoint that the effect of viewing angle controllability can be further exhibited, it is preferable to use the light absorption anisotropic film in an image display device in combination with the polarizer.

### Polarizer

The polarizer used in the viewing angle control system is not particularly limited as long as the polarizer is a member having an absorption axis in the in-plane direction and having a function of converting light into specific linearly polarized light, and a known polarizer in the related art can be used.

Examples of the polarizer include an iodine-based polarizer, a dye-based polarizer using a dichroic dye, and a polyene-based polarizer. Examples of the iodine-based polarizer and the dye-based polarizer include a coating type polarizer and a stretching type polarizer, and both polarizers can be applied. As the coating type polarizer, a polarizer in which a dichroic organic coloring agent is aligned by using alignment of the liquid crystal compound is preferable, and as the stretching type polarizer, a polarizer produced by adsorbing iodine or a dichroic dye on polyvinyl alcohol and stretching the polyvinyl alcohol is preferable.

In addition, examples of the method of obtaining a polarizer by stretching and dyeing a laminated film in which a polyvinyl alcohol layer is formed on a base material include methods described in JP5048120B, JP5143918B, JP5048120B, JP4691205B, JP4751481B, and JP4751486B, and known techniques related to these polarizers can also be preferably used.

Among these, from the viewpoint of availability and excellent polarization degree, a polarizer containing a polyvinyl alcohol-based resin (a polymer having —CH₂—CHOH— as a repeating unit; particularly at least one selected from the group consisting of polyvinyl alcohol and an ethylene-vinyl alcohol copolymer) is preferable.

A thickness of the polarizer is not particularly limited, but is preferably 3 to 60 μm, more preferably 5 to 20 μm, and still more preferably 5 to 10 μm.

### Other Members

The viewing angle control system may include other members such as a pressure-sensitive adhesive layer, an adhesive layer, an optically anisotropic film, a refractive index adjusting layer, and a barrier layer in addition to the above-described members.

The viewing angle control system may be manufactured by laminating the above-described light absorption anisotropic film or the above-described optical film with the above-described polarizer a pressure-sensitive adhesive layer or an adhesive layer described below. In addition, the viewing angle control system may be manufactured by directly laminating the above-described alignment film and the above-described light absorption anisotropic film on the above-described polarizer.

### Pressure-Sensitive Adhesive Layer

It is preferable that the pressure-sensitive adhesive layer is a transparent and optically isotropic adhesive similar to that used in a typical image display device, and a pressure-sensitive type adhesive is typically used.

The pressure-sensitive adhesive layer contains, for example, a parent material (pressure sensitive adhesive), conductive particles, and thermally expandable particles used as necessary. The pressure-sensitive adhesive layer may be blended with additives such as a crosslinking agent (such as an isocyanate-based crosslinking agent or an epoxy-based crosslinking agent), a viscosity imparting agent (such as a rosin derivative resin, a polyterpene resin, a petroleum resin, an oil-soluble phenol resin, and the like), a plasticizer, a filler, an antiaging agent, a surfactant, an ultraviolet absorbing agent, a light stabilizer, and an antioxidant in addition to the above-described components.

A thickness of the pressure-sensitive adhesive layer is, for example, 20 to 500 μm preferably 20 to 250 μm. In a case of being 20 μm or more, adhesive strength and rework suitability are excellent, and in a case of being 500 μm or less, it is possible to further suppress the pressure sensitive adhesive from bleeding out from peripheral edges of the image display device.

Examples of a method of forming the pressure-sensitive adhesive layer include a method of directly coating a support for a protective member with a coating solution containing the above-described components and a solvent and pressure-bonding the support through a release liner or a method of coating an appropriate release liner (release paper or the like) with a coating solution to form a thermally expandable pressure-sensitive adhesive layer, and pressure-bonding and transferring (transporting) the layer onto the support for a protective member.

In addition, for example, a configuration in which conductive particles are added to a thermally-releasable pressure-sensitive adhesive sheet described in JP2003-292916A can be employed as the protective member.

Furthermore, a member in which conductive particles are sprayed on the surface of a pressure-sensitive adhesive layer in commercially available products such as “REVALPHA” manufactured by Nitto Denko Corporation may be used as the protective member.

### Adhesive Layer

The adhesive layer contains at least an adhesive. The adhesive exhibits adhesiveness due to drying or a reaction after bonding.

A polyvinyl alcohol-based adhesive (PVA-based adhesive) exhibits adhesiveness due to drying, and is capable of bonding members to each other.

Specific examples of the curable adhesive which exhibits adhesiveness due to reaction include an active energy ray-curable adhesive such as a (meth) acrylate-based adhesive and a cationic polymerization curable adhesive. The (meth)acrylate denotes acrylate and/or methacrylate. Examples of the curable component in the (meth)acrylate-based adhesive include a compound having a (meth)acryloyl group and a compound having a vinyl group. In addition, as the cationic polymerization curable adhesive, a compound having an epoxy group or an oxetanyl group can also be used. The compound having an epoxy group is not particularly limited as long as the compound has at least two epoxy groups in a molecule, and various known curable epoxy compounds can be used. Preferred examples of the epoxy compound include a compound (aromatic epoxy compound) having at least two epoxy groups and at least one aromatic ring in the molecule and a compound (alicyclic epoxy compound) having at least two epoxy groups in the molecule, in which at least one of the epoxy groups is formed between two adjacent carbon atoms constituting an alicyclic ring.

Among these, from the viewpoint of heat deformation resistance, an ultraviolet curable adhesive which is cured by irradiation with ultraviolet rays is preferably used.

Each of the adhesive layer and the pressure-sensitive adhesive layer may have an ultraviolet absorbing ability. The layers can be imparted with the ultraviolet absorbing ability by a known method such performing a treatment with an ultraviolet absorbing agent such as a salicylic acid ester-based compound, a benzophenol-based compound, a benzotriazole-based compound, a cyanoacrylate-based compound, and a nickel complex salt-based compound.

The pressure-sensitive adhesive layer and the adhesive layer can be attached by an appropriate method. For example, the pressure-sensitive adhesive layer or the adhesive layer may be attached to the film by a method of preparing a pressure-sensitive adhesive solution having a concentration of 10% to 40% by weight, which is obtained by dissolving or dispersing a base polymer or a composition thereof in a solvent consisting of a single substance or a mixture of a solvent such as toluene or ethyl acetate, and directly attaching the solution on the film using a development method such as a casting method or a coating method; or a method of forming a pressure sensitive adhesive layer on a separator in conformity with the above-described method and transferring the layer.

The pressure-sensitive adhesive layer and the adhesive layer can also be provided on one or both surfaces of the film in a manner by superimposing different kinds of layers with different compositions. In addition, in a case where the pressure-sensitive adhesive layer is provided on both surfaces, the compositions, types, and thicknesses of the pressure-sensitive adhesive layers on the front and rear surfaces of the film may be the same or different from each other, respectively.

### Other Optically Anisotropic Films

The viewing angle control system may be used by combining the light absorption anisotropic film or the optical film with other optically anisotropic films or polarizers. In a case where the viewing angle control system includes other optically anisotropic films, the viewing angle controllability is further improved.

It is preferable that the other optically anisotropic films contain a dichroic substance as in the light absorption anisotropic film described above. The type of the dichroic substance is as described above.

In addition, it is preferable that the other optically anisotropic films contain a liquid crystal compound as in the light absorption anisotropic film described above. The type of the liquid crystal compound is as described above.

As a suitable aspect of the other optically anisotropic films, a layer in which the dichroic substance is aligned in a thickness direction or in an in-plane direction is preferable. The above-described suitable aspect can be formed by adding the dichroic substance to the liquid crystal compound and aligning the liquid crystal compound in a desired direction.

A method for forming the other optically anisotropic films is not particularly limited, and examples thereof include known methods. Among these, a method of using a composition containing the dichroic substance and the liquid crystal compound is preferable.

As the other optically anisotropic films, a resin film having optical anisotropy, which contains a polymer including carbonate, cycloolefin, cellulose acylate, methyl methacrylate, styrene, or maleic acid anhydride, can also be preferably used.

### Barrier Layer

The viewing angle control system may include a barrier layer. The barrier layer is also referred to as a gas-shielding layer (oxygen-shielding layer), and has a function of protecting the light absorption anisotropic film or the polarizer from gas such as oxygen in the atmosphere, moisture, rays, or a compound contained in an adjacent layer.

The barrier layer can refer to, for example, the description in paragraphs [0014] to [0054] of JP2014-159124A, paragraphs [0042] to [0075] of JP2017-121721A, paragraphs [0045] to [0054] of JP2017-115076A, paragraphs [0010] to [0061] of JP2012-213938A, and paragraphs [0021] to [0031] of JP2005-169994A.

### Refractive Index Adjusting Layer

The viewing angle control system may include a refractive index adjusting layer. In a case where the viewing angle control system includes a refractive index adjusting layer, influence of internal reflection caused by high refractive index of the light absorption anisotropic film can be suppressed.

The refractive index adjusting layer is disposed in contact with the light absorption anisotropic film, and has an in-plane average refractive index of 1.55 to 1.70 at a wavelength of 550 nm. It is preferable that the refractive index adjusting layer is a layer for performing so-called index matching.

### Image Display Device

All of the above-described light absorption anisotropic film, the above-described optical film, and the above-described viewing angle control system can be used for any image display device.

The image display device is not particularly limited, and examples thereof include liquid crystal display devices and self-luminous display devices (an organic electroluminescence (EL) display device and a micro light emitting diode (LED) display device).

Examples of the image display device include a device including a display panel and the above-described optical film or the above-described viewing angle control system, which is disposed on one main surface of the display panel. Examples of the display panel included in the image display device include a display panel including a liquid crystal cell and a display panel of a self-luminous display device, and the optical film of the viewing angle control system is disposed on these display panels.

The liquid crystal display device includes, for example, a liquid crystal cell and a backlight, and a polarizer is provided on both the viewing side and the backlight side of the liquid crystal cell. The viewing angle control system can be applied to any one or both surfaces on the viewing side or the backlight side of the liquid crystal display device. The application of the viewing angle control system to the liquid crystal display device can be achieved by replacing the polarizer on any one or both surfaces of the liquid crystal display device with the viewing angle control system. That is, as the polarizers provided on both sides of the liquid crystal cell, the polarizer included in the viewing angle control system can be used.

In a case where the viewing angle control system is applied to an organic EL display device, it is preferable that the viewing angle control system is disposed on the viewing side of the organic EL display device and the polarizer in the viewing angle control system is disposed on a side closer to the organic EL display device with respect to the light absorption anisotropic film. In addition, it is preferable that a κ/4 plate is disposed between the polarizer and the organic EL display device.

In the viewing angle control system in the image display device, it is preferable that the light absorption anisotropic film is disposed on the viewing side with respect to the polarizer.

Hereinafter, the liquid crystal cell constituting the liquid crystal display device will be described in detail.

### Liquid Crystal Cell

As the liquid crystal cell used in the liquid crystal display device, a vertical alignment (VA) mode, an optically compensated bend (OCB) mode, an in-plane-switching (IPS) mode, or a twisted nematic (TN) mode is preferable, but is not limited to these.

In the liquid crystal cell in a TN mode, rod-like liquid crystalline molecules are substantially horizontally aligned at the time of no voltage application and further twisted aligned at 60° to 120°. The liquid crystal cell in a TN mode is most frequently used as a color thin film transistor (TFT) liquid crystal display device and is described in a plurality of documents.

In the liquid crystal cell in a VA mode, rod-like liquid crystalline molecules are substantially vertically aligned at the time of no voltage application. The concept of the liquid crystal cell in a VA mode includes (1) a liquid crystal cell in a VA mode in a narrow sense where rod-like liquid crystalline molecules are aligned substantially vertically at the time of no voltage application and substantially horizontally at the time of voltage application (described in JP1990-176625A (JP-H2-176625A)), (2) a liquid crystal cell (in an MVA mode) (SID97, described in Digest of tech. Papers (proceedings) 28 (1997) 845) in which the VA mode is formed to have multi-domain in order to expand the viewing angle, (3) a liquid crystal cell in a mode (n-ASM mode) in which rod-like liquid crystalline molecules are substantially vertically aligned at the time of no voltage application and twistedly multi-domain aligned at the time of voltage application (described in proceedings of Japanese Liquid Crystal Conference, pp. 58 to 59 (1998)), and (4) a liquid crystal cell in a SURVIVAL mode (presented at LCD International 98). In addition, the liquid crystal cell in the VA mode may be any of a patterned vertical alignment (PVA) type, an optical alignment type, or a polymer-sustained alignment (PSA) type. The details of these modes are described in JP2006-215326A and JP2008-538819A.

In the liquid crystal cell in an IPS mode, rod-like liquid crystalline molecules are aligned substantially parallel to the substrate, and the liquid crystalline molecules respond planarly through application of an electric field parallel to the substrate surface. In the IPS mode, black display is carried out in a state where no electric field is applied, and absorption axes of a pair of upper and lower polarizers are orthogonal to each other. A method of reducing leakage light during black display in an oblique direction and improve the viewing angle using an optical compensation sheet is described in JP1998-054982A (JP-H10-054982A), JP1999-202323A (JP-H11-202323A), JP1997-292522A (JP-H9-292522A), JP1999-133408A (JP-H11-133408A), JP1999-305217A (JP-H11-305217A), and JP1998-307291A (JP-H10-307291A).

### EXAMPLES

Hereinafter, features of the present invention will be described in more detail with reference to Examples and Comparative Examples. The materials, amounts used, proportions, treatment details, treatment procedure, and the like shown in the following Examples can be appropriately changed without departing from the spirit and scope of the present invention. Therefore, the scope of the present invention should not be construed as being limited to the following specific examples.

### Example 1

The light absorption anisotropic film according to the embodiment of the present invention was manufactured by a method including, in the following order, a specific alignment film forming step of forming the specific alignment film, a coating film forming step of applying a composition for forming a light absorption anisotropic film onto the specific alignment film to form a coating film, and an alignment step of aligning liquid crystalline components contained in the coating film.

### Production of Light Absorption Anisotropic Film

### Specific Alignment Film Forming Step

A cellulose acylate film (TAC base material with a thickness of 40 μm; “TG40” manufactured by FUJIFILM Corporation) was cut into a size of 40 cm in width and 120 cm in length to obtain a transparent support (transparent base material film). One surface of the cut support was saponified with an alkaline solution, and the saponified surface was coated with the following coating liquid 1 for forming an alignment film using a wire bar to form a first coating film. The first coating film formed on the support was dried with hot air at 60° C. for 60 seconds and further dried with hot air at 100° C. for 120 seconds to form a resin film. A thickness of the resin film was 0.5 μm.

(Coating liquid 1 for forming alignment film)

| | | |
|---|---|---|
| Modified polyvinyl alcohol shown below | 3.80 | parts by mass |
| Initiator Irg2959 | 0.20 | parts by mass |
| Water | 70 | parts by mass |
| Methanol | 30 | parts by mass |

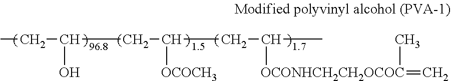

The following composition F1 for forming a photo-alignment film was applied onto the obtained resin film, and dried at 60° C. for 2 minutes to form a second coating film having a thickness of 0.03 μm.

The coating liquid F1 for forming a photo-alignment film was prepared by mixing the following components together, stirring the mixture for 1 hour, and then filtering the mixture through a 0.45 μm filter.

Composition F1 for forming photo-alignment film

| | | |
|---|---|---|
| Photo-alignment material F1 shown below | 0.3 | parts by mass |
| 2-Butoxyethanol | 41.6 | parts by mass |
| Dipropylene glycol monomethyl ether | 41.6 | parts by mass |
| Pure water | 16.5 | parts by mass |

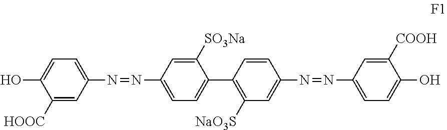

As shown in FIG. 5A, the coating film of the composition for forming a photo-alignment film, which had been formed on the support, was divided into two regions of the first region 51 on the negative direction side of the X-axis and the second region 52 on the positive direction side of the X-axis by the boundary line L which was equidistant from both ends in a longitudinal direction (X-axis direction). In both the first region 51 and the second region 52, the length of the short side (width) along the Y-axis direction was 40 cm, and the length of the long side along the X-axis direction was 60 cm.

As a photo alignment treatment, the first region 51 and the second region 52 of the coating film 50 were irradiated with polarized ultraviolet rays in different directions.

First, as shown in FIG. 5B, the mask M was disposed to cover an upper side of the second region 52 of the coating film 50 so that the second region 52 was shielded from light, and the exposed first region 51 was irradiated with polarized ultraviolet rays (irradiation amount: 2000 J/cm²) using an ultraviolet exposure device from the positive direction of the Z-axis (direction of the angle θ=0°.

Next, as shown in FIG. 5C, by moving the mask M to a position which covered an upper side of the first region 51 so that only the first region 51 was shielded from light, and the exposed second region 52 was irradiated with polarized ultraviolet rays (irradiation amount: 2000 mJ/cm²) using an ultraviolet exposure device from a direction of the angle θ=35° and the angle φ=0°.

As a result, an alignment film F in which the directions of the alignment regulating force were different from each other in the first region 51 and the second region 52 was formed.

### Coating Film Forming Step

The following composition P1 for forming a light absorption anisotropic film was applied onto a surface of the alignment film F formed in the above-described specific alignment film forming step using a wire bar to form a coating film P1.

Formulation of composition P1 for forming
light absorption anisotropic film

| | | |
|---|---|---|
| Liquid crystalline compound L1 | 3.977 | parts by mass |
| Liquid crystalline compound L2 | 2.593 | parts by mass |
| Dichroic substance Y1 | 0.294 | parts by mass |
| Dichroic substance M1 | 0.130 | parts by mass |
| Dichroic substance C1 | 0.873 | parts by mass |
| Polymerization initiator | | |
| IRGACURE OXE-02 | 0.130 | parts by mass |
| (manufactured by BASF SE) | | |
| Interface improver B1 | 0.003 | parts by mass |
| Cyclopentanone | 82.800 | parts by mass |
| Tetrahydrofuran | 9.200 | parts by mass |

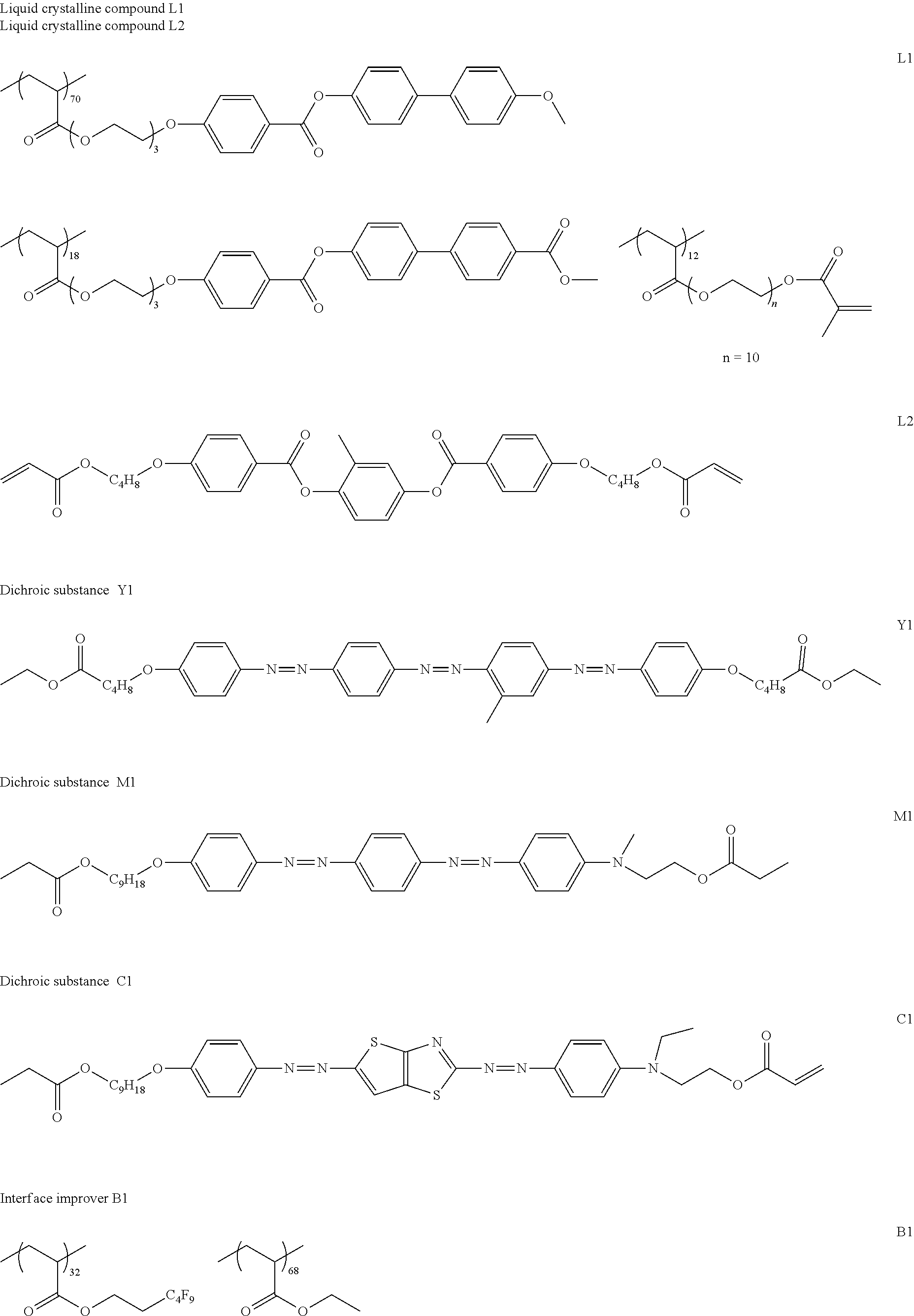

### Alignment Step

Next, the coating film P1 formed in the coating film forming step was heated at 120° C. for 30 seconds, and cooled to 100° C.

Thereafter, the heated coating film P1 was irradiated with light of an LED lamp (central wavelength: 365 nm) under an irradiation condition of an illuminance of 200 mW/cm² at room temperature (25° C.) for 2 seconds to produce a light absorption anisotropic film P1 on the surface of the alignment film F, thereby obtaining an optical film P1 including the transparent support, the alignment film F, and the light absorption anisotropic film P1 in this order.

### Measurement of Direction of Transmittance Central Axis

Each sample having a size of 4 cm×4 cm was cut out from regions of the obtained optical film P1, corresponding to the first region 51 and the second region 52. Next, using an ultraviolet-visible-infrared spectrophotometer “JASCO V-670/ARMN-735” (manufactured by JASCO Corporation), according to the method described above, each sample was set on a sample stage so that the film surface was horizontal, and then was irradiated with P-polarized light having a wavelength of 550 nm, and the direction of the transmittance central axis of each sample was measured. In this manner, the angle θ between the direction of the transmittance central axis and the normal line of the surface of the light absorption anisotropic film P1 and the angle φ of orthographic projection of the transmittance central axis onto the surface of the light absorption anisotropic film P1 with respect to a reference direction were obtained. As the reference direction of the angle φ, the negative direction of the X-axis (longitudinal direction) in the light absorption anisotropic film P1 was used.

As a result of the measurement, the transmittance central axis of the sample of the optical film P1 obtained from the first region 51 was along the normal line of the light absorption anisotropic film P1. That is, the angle θ between the transmittance central axis and the normal line of the light absorption anisotropic film P1 was 0°.

On the other hand, the transmittance central axis of the sample of the optical film P1 obtained from the second region 52 was tilted at an angle of 34° with respect to the normal line of the light absorption anisotropic film P1. In other words, the angle θ between the transmittance central axis and the normal line of the optical film P1 in the second region 52 was 34°. In addition, in the sample of the optical film P1 obtained from the second region 52, the orthographic projection of the transmittance central axis onto the surface of the light absorption anisotropic film extended in a direction of the angle φ=0°.

Therefore, in the light absorption anisotropic film P1 obtained in Example 1, as shown in FIG. 1, it was confirmed that the first region 51 in which the angle θ indicating the direction of the transmittance central axis was 0° and the second region 52 in which the angle θ and the angle φ indicating the direction of the transmittance central axis were each 34° and 0° were arranged in the X-axis direction.

### Production of Image Display Device

The following composition G for forming a barrier layer was continuously applied onto the surface of the light absorption anisotropic film P1 in the optical film P1 obtained above using a wire bar to form a coating film.

Next, by blowing hot air at 60° C. for 60 seconds and further blowing hot air at 100° C. for 120 seconds to the formed coating film, the coating film was dried to form a barrier layer G, thereby obtaining an optical film with a barrier layer. A film thickness of the barrier layer G was 1.0 μm.

(Composition G for forming barrier layer)

| | | |
|---|---|---|
| Modified polyvinyl alcohol PVA-1 shown above | 3.88 | parts by mass |
| IRGACURE 2959 | 0.20 | parts by mass |
| Water | 70 | parts by mass |
| Methanol | 30 | parts by mass |

An image display device (“iPad (registered trademark) 2 WiFi mode 16 GB”, manufactured by Apple Inc.) was disassembled, an image display pane(width of 14.8 cm and length of 19.7 cm) was disassembled, a liquid crystal cell was taken out, and a viewing side polarizing plate was peeled off from the liquid crystal cell. Next, a glass plate having the same size (width of 40 cm and length of 120 cm) as the above-described optical film with a barrier layer was prepared, and two image display panels described above were attached to each of predetermined positions of the glass plate. Next, using the following pressure sensitive adhesive sheet, the produced optical film with a barrier layer was laminated on a surface of the glass plate to which the image display panels had been attached on a side opposite to the image display panels such that the barrier layer G faced the glass plate, thereby producing an image display device.

### Preparation of Pressure Sensitive Adhesive Sheet

An acrylate-based polymer was prepared according to the following procedure.

95 parts by mass of butyal crylate and 5 parts by mass of acrylic acid were charged into and mixed in a reaction container equipped with a cooling pipe, a nitrogen introduction pipe, a thermometer, and a stirrer. The obtained mixture was polymerized by a solution polymerization method, thereby obtaining an acrylate-based polymer A1 with an average molecular weight of 2,000,000 and a molecular weight distribution (Mw/Mn) of 3.0.

The obtained acrylate-based polymer A1 (100 parts by mass), CORONATE L (75% by mass ethyl acetate solution of a trimethylolpropane adduct of tolylene isocyanate, number of isocyanate groups in one molecule: 3, manufactured by Nippon Polyurethane Industry Co., Ltd.) (1.0 part by mass), and a silane coupling agent KBM-403 (manufactured by Shin-Etsu Chemical Co., Ltd.) (0.2 parts by mass) were mixed with each other, and ethyl acetate was added to the obtained mixture so that the concentration of total solid content was 10% by mass to prepare a composition for forming a pressure sensitive adhesive. A separate film subjected to a surface treatment with a silicone-based release agent was coated with the composition using a die coater, and the formed coating film was dried in an environment of 90° C. for 1 minute to obtain an acrylate-based pressure sensitive adhesive sheet. A film thickness of the obtained pressure sensitive adhesive sheet was 25 μm, and a storage elastic modulus thereof was 0.1 MPa.

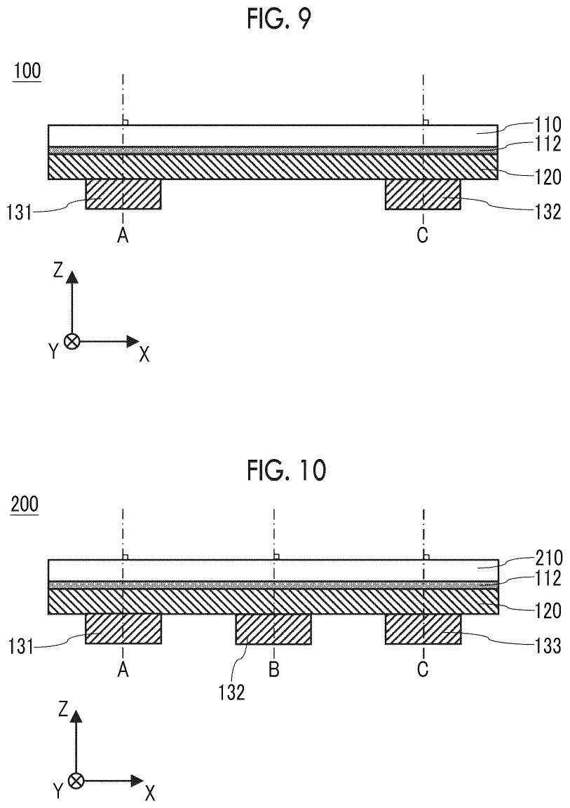

FIG. 9 shows a configuration of the image display device produced in Example 1.

FIG. 9 is a side view of an elongated image display device 100 observed from an in-plane width direction (negative direction of the Y-axis) of the image display device 100. As shown in FIG. 9, the image display device 100 included an optical film 110 with a barrier layer, a pressure sensitive adhesive sheet 112, a glass plate 120, a first panel 131, and a second panel 132. In the light absorption anisotropic film (not shown) included in the optical film 110 with a barrier layer, the above-described first region in which the angle θ of the transmittance central axis was 0° was disposed on the negative direction side of the X-axis, and the second region in which the angle θ of the transmittance central axis was 34° and the angle φ of the orthographic projection of the transmittance central axis was 0° was disposed on the positive direction side of the X-axis.

In addition, the first panel 131 was provided at a position (hereinafter, also referred to as “position I”) where the center of the X-axis direction of the first panel 131 was separated by 20 cm from the end of the optical film 110 with a barrier layer on the negative direction side of the X-axis, and the second panel 132 was provided at a position (hereinafter, also referred to as “position III”) where the center of the X-axis direction of the second panel 132 was separated by 100 cm from the end.

### Evaluation

### Visibility

The image display device 100 produced in Example 1 was observed from an observation position 140 cm away from the position I where the first panel 131 was provided in a laminating direction (positive direction of the Z-axis). For each of the first panel 131 provided at the position I and the second panel 132 provided at the position III, visibility (clearness) of a displayed image was evaluated based on the following evaluation standard.

### Evaluation Standard of Visibility

“A”: displayed image was clearly visible.

“B”: displayed image was visible.

“C”: displayed image was not visible.

### Reflected Glare

The image display device 100 in which the optical film 110 with a barrier layer was disposed vertically above was installed at an angle so that an elevation angle from a horizontal plane was 30° in a case of being observed from the negative direction side of the Y-axis to the positive direction side of the Y-axis. Next, a glass plate R (width of 40 cm and length of 120 cm) for evaluation of reflected glare was disposed above the image display device 100 so that a longitudinal direction of the glass plate R was along the horizontal direction. In this case, the glass plate R was disposed such that a plane including the normal line of the display surface (surface of the optical film 110 with a barrier layer) of the image display device 100 and the normal line of the glass plate R included the vertical direction and an angle between the normal line of the image display device 100 and the normal line of the glass plate R was 85°. In addition, the glass plate R was disposed at a position where a distance between the center of the surface of the glass plate R facing the image display device 100 and the center of the display surface of the image display device 100 was 50 cm.

Using the image display device 100 and the glass plate R installed as described above, reflected glare (reflected image) of the displayed image on the surface of the glass plate R was observed and evaluated. In the evaluation of reflected glare, the image was observed from an observation position corresponding to the position III where the second panel 132 of the image display device 100 was provided. More specifically, the observation position was set to a position existing on a plane (YZ plane) including the above-described position III, the normal line of the display surface of the image display device 100, and the normal line of the glass plate R, in which a distance from an intersection a between a center line equidistant from the long side of the surface of the glass plate R and the YZ plane to the observation position was 140 cm, and an angle between a straight line connecting the observation position and the intersection α and the normal line of the glass plate R was 20°. The displayed image of the first panel 131 provided at the position I of the image display device 100 and the displayed image of the second panel 132 provided at the position III, which were reflected by the glass plate R, were observed from the observation position, and from each observation result, reflected glare of the displayed image was evaluated based on the following evaluation standard.

### Evaluation Standard of Reflected Glare

“A”: reflected image was weakly visible.

“B”: reflected image was visible.

“C”: reflected image was strongly visible.

### Example 2

An optical film with a barrier layer was produced according to the method described in Example 1, except that, in the specific alignment film forming step of Example 1, the coating film of the composition for forming a photo-alignment film, formed on the support, was divided into three regions having equal lengths in the longitudinal direction, and as the photo alignment treatment, each region was irradiated with polarized ultraviolet rays from different directions.

More specifically, in the specific alignment film forming step, the coating film of the composition for forming a photo-alignment film, formed on the support, was divided into three regions having equal lengths in the longitudinal direction. In all of these three regions, the length in the Y-axis direction was 40 cm and the length in the X-axis direction was 40 cm.

Next, as the photo alignment treatment, as shown in FIG. 6, the first region 61, the second region 62, and the third region 63 of the coating film 60 were irradiated with polarized ultraviolet rays (irradiation amount: 2000 mJ/cm²) using an ultraviolet exposure device from different directions.

First, as shown in FIG. 6A, the second region 62 and the third region 63 were shielded from light using the mask M, and the exposed first region 61 was irradiated with polarized ultraviolet rays from the positive direction of the Z-axis (a direction of angle θ=0°. Next, as shown in FIG. 6B, the first region 61 and the third region 63 were shielded from light using the mask M, and the exposed second region 62 was irradiated with polarized ultraviolet rays from a direction of the angle θ=15° and the angle φ =0°. Next, as shown in FIG. 6C, the first region 61 and the second region 62 were shielded from light using the mask M, and the exposed third region 63 was irradiated with polarized ultraviolet rays from a direction of the angle θ=35° and the angle φ=0°.

As a result, an alignment film F in which the directions of the alignment regulating force were different from each other in the first region 61, the second region 62, and the third region 63 was formed.

According to the methods described in Example 1, a light absorption anisotropic film P2 was produced on the surface of the alignment film F to obtain an optical film P2 including the transparent support, the alignment film F, and the light absorption anisotropic film P2 in this order, except that the alignment film F formed in the above-described specific alignment film forming step was used.

Samples cut out from regions of the obtained optical film P2, corresponding to the first region, the second region, and the third region described above, was obtained according to the method described in <Measurement of direction of transmittance central axis> in Example 1. With the samples, the angle θ between the direction of the transmittance central axis and the normal line of the surface of the light absorption anisotropic film P2 and the angle φ of orthographic projection of the transmittance central axis onto the surface of the light absorption anisotropic film P2 with respect to a reference direction were obtained.

The measurement results are shown in Table 1 described later.

An image display device was produced according to the method described in <Production of image display device>of Example 1, except that the optical film P2 obtained above was used. However, in Example 2, three image display panels were attached to predetermined positions of the glass plate.

FIG. 10 shows a configuration of the image display device produced in Example 2.

FIG. 10 is a side view of an elongated image display device 200 observed from an in-plane width direction (negative direction of the Y-axis) of the image display device 200. As shown in FIG. 10, the image display device 200 included an optical film 210 with a barrier layer, a pressure sensitive adhesive sheet 112, a glass plate 120, a first panel 131, a second panel 132, and a third panel 133. In the light absorption anisotropic film (not shown) included in the optical film 210 with a barrier layer, from the negative direction side of the X-axis, the above-described first region in which the angle θ of the transmittance central axis was 0°, the second region in which the angle θ of the transmittance central axis was 15° and the angle φ of the orthographic projection of the transmittance central axis was 0°, and the third region in which the angle θ of the transmittance central axis was 35° and the angle 0° of the orthographic projection of the transmittance central axis was 0° were arranged in this order.

In addition, the first panel 131 was provided at the position I in the image display device of Example 1, the second panel 132 was provided at a position (hereinafter, also referred to as “position II”) where the center of the X-axis direction of the second panel 132 was separated by 60 cm from the end of the optical film 210 with a barrier layer on the negative direction side of the X-axis, and the third panel 133 was provided at the position III in the image display device of Example 1.

### Evaluation

### Visibility

The image display device 200 produced in Example 2 was observed from an observation position 140 cm away from the position I where the first panel 131 was provided in a laminating direction (positive direction of the Z-axis).

From the obtained observation results, for each of the first panel 131 provided at the position I, the second panel 132 provided at the position II, and the third panel 133 provided at the position III, visibility (clearness) of the displayed image was evaluated based on the same evaluation standard as in Example 1.

### Reflected Glare

A reflected image of the displayed image of the image display device 200, reflected on the glass plate R, was observed according to the method of evaluating the reflected glare in Example 1, and reflected glare of the displayed image on the glass plate R was evaluated. That is, the image display device 200 and the glass plate R were installed according to the method described in Example 1, and the reflected glare on the glass plate R was observed from the same observation position (position on the YZ plane including the position III) as in Example 1. In Example 2, for each of the displayed image of the first panel 131 provided at the position I, the displayed image of the second panel 132 provided at the position II, and the displayed image of the third panel 133 provided at the position III, the reflected glare of the reflected image was evaluated.

### Example 3

An optical film with a barrier layer was produced according to the method described in Example 2, except that, in the specific alignment film forming step of Example 2, the irradiation direction of the polarized ultraviolet rays radiated to the first region 61, the second region 62, and the third region 63 of the coating film 60 was changed as follows.

More specifically, the first region 61 was irradiated with polarized ultraviolet rays from a direction of the angle θ=30° and the angle φ=180°, the second region 62 was irradiated with polarized ultraviolet rays from the positive direction of the Z-axis (a direction of the angle θ=0°), and the third region 63 was irradiated with polarized ultraviolet rays from a direction of the angle θ=30° and the angle φ=0°.

As a result, an alignment film F in which the directions of the alignment regulating force were different from each other in the first region 61, the second region 62, and the third region 63 was formed, thereby producing an optical film with a barrier layer of Example 3.

An image display device was produced using the produced optical film with a barrier layer according to the method described in Example 2.

### Evaluation

### Visibility

The image display device produced in Example 3 was observed from an observation position 100 cm away from the position II where the second panel was provided in a laminating direction (positive direction of the Z-axis).

From the obtained observation results, for each of the first panel provided at the position I, the second panel provided at the position II, and the third panel provided at the position III, visibility (clearness) of the displayed image was evaluated based on the same evaluation standard as in Example 1.

### Reflected Glare

A reflected image of the displayed image of the image display device, reflected on the glass plate R, was observed according to the method of evaluating the reflected glare in Example 2, and reflected glare of the displayed image on the glass plate R was evaluated.

### Example 4

An optical film with a barrier layer was produced according to the method described in Example 1, except that, in Example 1, the photo alignment treatment in the specific alignment film forming step was changed as follows.

That is, a mold having a width of 40 cm, a length of 120 cm, and a curvature of 0.0131 [l/cm] was produced, and a base material on which the coating film of the composition for forming an alignment film had been formed was placed along the surface of the produced mold. Next, as shown in FIG. 7, the surface of the coating film was irradiated with polarized ultraviolet rays (irradiation amount: 2000 mJ/cm²) from a normal direction (positive direction of the Z-axis shown in FIG. 7) to a contact surface of the coating film at a position where the length from both ends in the longitudinal direction of the coating film was 60 cm. After the irradiation, the obtained alignment film was peeled off from the mold to form an alignment film F in which the direction (angle θ) of the alignment regulating force changed in a continuous manner in the longitudinal direction, and using the obtained alignment film F, an optical film with a barrier layer of Example 4 was produced.

An image display device was produced using the produced optical film with a barrier layer according to the method described in Example 2.

### Evaluation

With the produced image display device, according to the evaluation methods described in Example 3, evaluation of visibility and evaluation of reflected glare were performed.

### Comparative Example 1

An optical film with a barrier layer of Comparative Example 1 was produced according to the method described in Example 1, except that, instead of the specific alignment film forming step of Example 1, a step of irradiating the entire surface of the coating film of the composition for forming a photo-alignment film, formed on the support, with polarized ultraviolet rays from the positive direction of the Z-axis (a direction of the angle θ=0° to produce an alignment film in which the direction of the alignment regulating force was parallel to the entire surface.

An image display device was produced using the produced optical film with a barrier layer according to the method described in Example 2.

With the produced image display device, according to the evaluation methods described in Example 2, evaluation of visibility and evaluation of reflected glare were performed.

Table 1 shows characteristics of the light absorption anisotropic film produced in each of Examples and Comparative Example, and the evaluation results thereof.

In Table 1, the column of “Light absorption anisotropic film” indicates the direction of the transmittance central axis in the in-plane direction of the light absorption anisotropic film produced in each of Examples and Comparative Example. In addition, the column of “Angle θ” indicates the angle between the transmittance central axis and the normal line of the surface of the light absorption anisotropic film, and the column of “Angle φ” indicates the angle between the orthographic projection of the transmittance central axis onto the light absorption anisotropic film and the longitudinal direction of the light absorption anisotropic film.

In Table 1, “Continuous change” in Example 4 denotes that the angle θ indicating the direction of the transmittance central axis changed in a continuous manner along the longitudinal direction of the light absorption anisotropic film. In addition, the column of “Angle θ” of Example 4 denotes that the angle θ between the transmittance central axis and the normal line of the surface of the light absorption anisotropic film decreased in a continuous manner from both ends in the X-axis direction toward the center, the angle θ at the position I and the position III was 30°, and the angle θ at the position II was 0° . In addition, the column of “Angle φ” of Example 4 denotes that, in the light absorption anisotropic film, the angle φ was 0° or 180° except for the position II where the angle θ was 0° .

In Table 1, “I”, “II”, and “III” in the columns of “Visibility” and “Reflected glare” indicate the position of the image display panel subjected to each evaluation.

TABLE 1

| | | | | | Evaluation result | | | | | |
|---|---|---|---|---|---|---|---|---|---|---|
| | | Light absorption anisotropic film | | | Visibility | | | Reflected glare | | |
| | | First region | Second region | | I | II | III | I | II | III |
| Example 1 | Angle θ | 0 | 34 | | A | — | A | A | — | A |
| | Angle φ | — | 0 | | | | | | | |
| | | First region | Second region | Third region | | | | | | |
| Example 2 | Angle θ | 0 | 15 | 35 | A | A | A | A | B | A |
| | Angle φ | — | 0 | 0 | | | | | | |
| Example 3 | Angle θ | 30 | 0 | 30 | A | A | A | A | B | A |
| | Angle φ | 180 | — | 0 | | | | | | |

| | | Continuous change | | | | | | |
|---|---|---|---|---|---|---|---|---|
| Example 4 | Angle θ | 30~0~30 | A | A | A | A | B | A |
| | Angle φ | 180~180 (−) 0~0 | | | | | | |
| | | Same through entire surface | | | | | | |
| Comparative | Angle θ | 0 | A | C | C | A | B | C |
| Example 1 | Angle φ | — | | | | | | |

As shown in Table 1, it was confirmed that, in the light absorption anisotropic films according to the embodiment of the present invention of Examples 1 to 4, the visibility of the displayed image was excellent in all positions I to III and the effect of the present invention was excellent.

### Example 5

A cellulose acylate film (TAC base material with a thickness of 40 μm; “TG40” manufactured by FUJIFILM Corporation) was cut into a size of 30 cm in width and 60 cm in length to obtain a transparent support (transparent base material film). One surface of the cut support was saponified with an alkaline solution, and the saponified surface was coated with the above-described coating liquid 1 for forming an alignment film using a wire bar to form a first coating film. The first coating film formed on the support was dried with hot air at 60° C. for 60 seconds and further dried with hot air at 100° C. for 120 seconds to form a resin film. A thickness of the resin film was 0.5 μm.

The above-described composition F1 for forming a photo-alignment film was applied onto the obtained resin film, and dried at 60° C. for 2 minutes to form a second coating film having a thickness of 0.03 μm.

The coating film of the composition for forming a photo-alignment film, which had been formed on the support, was divided into two regions of the first region on the negative direction side of the Y-axis and the second region on the positive direction side of the Y-axis by the boundary line which was equidistant from both ends in a longitudinal direction (Y-axis direction). In both the first region and the second region, the length in the Y-axis direction was 30 cm and the length in the X-axis direction was 30 cm.

Next, as the photo alignment treatment, the first region and the second region of the coating film were irradiated with polarized ultraviolet rays (irradiation amount: 2000 mJ/cm²) using an ultraviolet exposure device from different directions.

First, as shown in FIG. 8A, the second region 82 of the coating film 80 was shielded from light using the mask M, and the exposed first region 81 was irradiated with polarized ultraviolet rays from a direction of the angle θ=30° and the angle φ=0° .

Next, as shown in FIG. 8B, the first region 81 of the coating film 80 was shielded from light using the mask M, and the exposed second region 82 was irradiated with polarized ultraviolet rays from a direction of the angle θ=30° and the angle φ=50° .

As a result, an alignment film F in which the directions of the alignment regulating force were different from each other in the first region 81 and the second region 82 was formed.

According to the methods described in Example 1, a light absorption anisotropic film P5 was produced on the surface of the alignment film F to obtain an optical film P5 including the transparent support, the alignment film F, and the light absorption anisotropic film P5 in this order, except that the alignment film F formed in the above-described specific alignment film forming step was used.

Samples cut out from regions of the obtained optical film P5, corresponding to the first region and the second region described above, was obtained according to the method described in <Measurement of direction of transmittance central axis>in Example 1. With the samples, the angle θ between the direction of the transmittance central axis and the normal line of the surface of the light absorption anisotropic film P5 and the angle φ of orthographic projection of the transmittance central axis onto the surface of the light absorption anisotropic film P5 with respect to a reference direction were obtained. As the reference direction of the angle φ, the negative direction of the X-axis (width direction) in the light absorption anisotropic film P5 was used.

As a result of the measurement, the transmittance central axis of the sample of the optical film P5 obtained from the first region was tilted at an angle of 31° with respect to the normal line of the light absorption anisotropic film P5. That is, the angle θ between the transmittance central axis and the normal line of the optical film P5 in the first region was 31°. In addition, in the sample of the optical film P5 obtained from the first region, the orthographic projection of the transmittance central axis onto the surface of the light absorption anisotropic film extended in a direction of the angle φ=0°.

In addition, the angle θ between the transmittance central axis and the normal line of the sample of the optical film P5 obtained from the second region was 31°, and in the sample of the optical film P5 obtained from the second region, the orthographic projection of the transmittance central axis onto the surface of the light absorption anisotropic film extended in a direction of the angle φ=49°.

Therefore, in the light absorption anisotropic film P5 obtained in Example 5, as shown in FIG. 4, it was confirmed that the first region 81 in which the angle θ and the angle φ indicating the direction of the transmittance central axis were each 31° and 0° and the second region 82 in which the angle θ and the angle φ indicating the direction of the transmittance central axis were each 31° and 49° were arranged in the Y-axis direction.

### Production of Image Display Device

The above-described composition G for forming a barrier layer was continuously applied onto the surface of the light absorption anisotropic film P5 in the optical film P5 obtained above using a wire bar to form a coating film.

Next, by blowing hot air at 60° C. for 60 seconds and further blowing hot air at 100° C. for 120 seconds to the formed coating film, the coating film was dried to form a barrier layer G, thereby obtaining an optical film with a barrier layer. A film thickness of the barrier layer G was 1.0 μm.

An image display device (“iPad (registered trademark) 2 WiFi model 16 GB”, manufactured by Apple Inc.) was disassembled, an image display pane(width of 14.8 cm and length of 19.7 cm) was disassembled, a liquid crystal cell was taken out, and a viewing side polarizing plate was peeled off from the liquid crystal cell. Next, a glass plate having the same size (width of 30 cm and length of 60 cm) as the above-described optical film with a barrier layer was prepared, and two image display panels described above were attached to each of predetermined positions of the glass plate. Next, using the above-described pressure sensitive adhesive sheet, the produced optical film with a barrier layer was laminated on a surface of the glass plate to which the image display panels had been attached on a side opposite to the image display panels such that the barrier layer G faced the glass plate, thereby producing an image display device.

The produced image display device included the optical film with a barrier layer, the pressure sensitive adhesive sheet, and the glass plate, and further included the first panel and the second panel as the image display panel. In the light absorption anisotropic film (not shown) included in the optical film with a barrier layer, the first region in which the angle θ of the transmittance central axis was 31° and the angle φ of the orthographic projection of the transmittance central axis was 0°, and the second region in which the angle θ of the transmittance central axis was 31 and the angle φ of the orthographic projection of the transmittance central axis was 49 were arranged in the longitudinal direction.

In the produced image display device, the first panel was provided at a position (hereinafter, also referred to as “position IV”) where the center of the lateral direction of the first panel was separated by 10 cm from the end of the optical film with a barrier layer on the first region side, and the second panel was provided at a position (hereinafter, also referred to as “position VI”) where the center of the lateral direction of the second panel was separated by 50 cm from the end of the optical film with a barrier layer on the first region side in the longitudinal direction.

### Evaluation

### Visibility

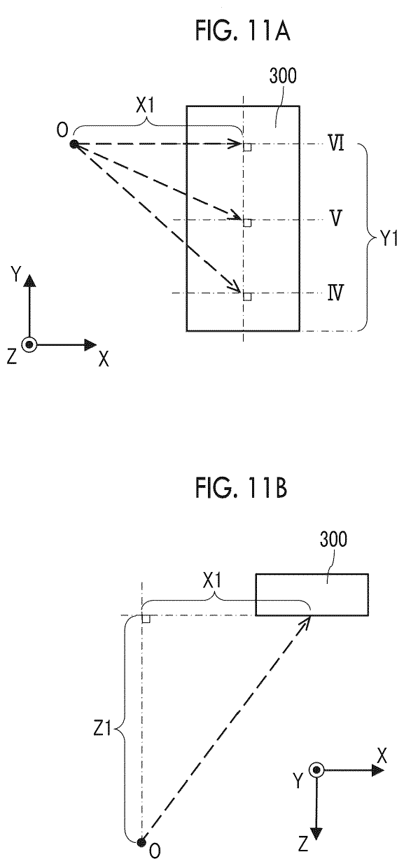

FIGS. 11A and 11B are diagrams for describing an evaluation method of the image display device produced in Example 5, and are schematic views showing a position O of an observer in a case where an image display device 300 is evaluated.

The image display device 300 was installed such that a longitudinal direction of the image display device 300 was along a vertical direction (Y-axis direction), and the first region was disposed on the lower side and the second region was disposed on the upper side.

FIG. 11A is a front view of the surface of the image display device 300 in stalled as described above in a case of being observed from a normal direction, and FIG. 11B is a top view of the image display device 300 in a case of being observed from vertically above.

FIG. 11A shows the position IV, a position V (see Example 6), and the position VI in the image display device 300.

A height Y1 from a lower end of the image display device 300 shown in FIG. 11A to the position O of the observer was 50 cm, which was the same height as the position VI.

In addition, as shown in FIGS. 11A and 11B, a distance X1 in the X-axis direction from the center of the image display device 300 in the lateral direction (X-axis direction) to the position O of the observer was 45 cm. The image display device 300 was located on the positive direction side of the X-axis (the right side of the paper plane) in a view from the observer.

In addition, as shown in FIG. 11B, a distance Z1 from the position O of the observer to a plane (XY plane) including the surface of the image display device 300 was 70 cm.

From such a position O of the observer, for each of the first panel provided at the position IV and the second panel provided at the position VI, visibility (clearness) of the displayed image was evaluated based on the same evaluation standard as in Example 1.

### Example 6

An alignment film was produced according to the method described in Example 5, except that, in the specific alignment film forming step of Example 6, the coating film of the composition for forming a photo-alignment film, formed on the support, was divided into three regions having equal lengths in the longitudinal direction, and as the photo alignment treatment, each region was irradiated with polarized ultraviolet rays from different directions.

More specifically, in the specific alignment film forming step, the coating film of the composition for forming a photo-alignment film, formed on the support, was divided into three regions of the first region, the second region, and the third region, having equal lengths in the longitudinal direction of the coating film. In all of these three regions, the length of the coating film in the longitudinal direction was 20 cm and the length of the coating film in the lateral direction was 30 cm.

Next, as the photo alignment treatment, the first region, the second region, and the third region of the coating film were irradiated with polarized ultraviolet rays (irradiation amount: 2000 mJ/cm²) using an ultraviolet exposure device from different directions.

First, the second region and the third region were shielded from light using the mask M, and the exposed first region was irradiated with polarized ultraviolet rays from a direction of the angle θ=30° and the angle φ=0°. Next, the first region and the third region were shielded from light using the mask M, and the exposed second region was irradiated with polarized ultraviolet rays from a direction of the angle θ=30° and the angle φ=30°. Next, the first region and the second region were shielded from light using the mask M, and the exposed third region was irradiated with polarized ultraviolet rays from a direction of the angle θ=30° and the angle φ=5 0°. In a case where the coating film of the composition for forming a photo-alignment film, formed on the support, was observed from the front, a direction in which the in-plane of the coating film was rotated by 90° counterclockwise with respect to the direction in which the first region, the second region, and the third region were arranged in this order was defined as a reference (φ=0°) of the angle φ indicating the irradiation direction of the polarized ultraviolet rays.

As a result, an alignment film F in which the directions of the alignment regulating force were different from each other in the first region, the second region, and the third region was formed.

According to the methods described in Example 5, a light absorption anisotropic film P6 was produced on the surface of the alignment film F to obtain an optical film P6 including the transparent support, the alignment film F, and the light absorption anisotropic film P6 in this order, except that the alignment film F formed in the above-described specific alignment film forming step was used.

Samples cut out from regions of the obtained optical film P6, corresponding to the first region, the second region, and the third region described above, was obtained according to the method described in Example 5. With the samples, the angle θ between the direction of the transmittance central axis and the normal line of the surface of the light absorption anisotropic film P6 and the angle φ of orthographic projection of the transmittance central axis onto the surface of the light absorption anisotropic film P6 with respect to a reference direction were obtained.

The measurement results are shown in Table 2 described later.

An image display device was produced according to the method described in <Production of image display device> of Example 5, except that the optical film P6 obtained above was used. However, in Example 6, three image display panels were attached to predetermined positions of the glass plate.

In the image display device produced in Example 6, the first panel was provided at the position IV in the image display device, the second panel was provided at a position (hereinafter, also referred to as “position IV”) where the center of the lateral direction of the first panel was separated by 30 cm from the end of the optical film with a barrier layer on the first region side in the longitudinal direction of the image display device, and the third panel was provided at the position VI in the image display device.

### Evaluation

### Visibility

With regard to the obtained image display device, according to the method described in Example 5, from the position O of the observer, for each of the first panel provided at the position IV, the second panel provided at the position V, and the third panel provided at the position VI, visibility (clearness) of the displayed image was evaluated based on the same evaluation standard as in Example 1.

### Comparative Example 2

An optical film with a barrier layer of Comparative Example 2 was produced according to the method described in Example 5, except that, instead of the specific alignment film forming step of Example 5, a step of irradiating the entire surface of the coating film of the composition for forming a photo-alignment film, formed on the support, with polarized ultraviolet rays from the direction of the angle θ=30° and the angle φ=0° to produce an alignment film in which the direction of the alignment regulating force was parallel to the entire surface.

An image display device was produced using the produced optical film with a barrier layer according to the method described in Example 5, and with the produced image display device, according to the evaluation method described in Example 5, evaluation of visibility was performed.

Table 2 shows characteristics of the light absorption anisotropic film produced in each of Examples and Comparative Example 2, and the evaluation results thereof.

In Table 2, the column of “Light absorption anisotropic film” indicates the direction of the transmittance central axis in the in-plane direction of the light absorption anisotropic film produced in each of Examples and Comparative Example. In addition, the column of “Angle θ” indicates the angle between the transmittance central axis and the normal line of the surface of the light absorption anisotropic film, and the column of “Angle φ” indicates the angle between the orthographic projection of the transmittance central axis onto the light absorption anisotropic film and the lateral direction of the light absorption anisotropic film.

In Table 2, “IV”, “V”, and “VI” in the column of “Visibility” indicate the position of the image display panel subjected to each evaluation.

TABLE 2

| | | | | | Evaluation | | |
|---|---|---|---|---|---|---|---|
| | | | | | result | | |
| | | Light absorption anisotropic film | | | visibility | | |
| | | First region | Second region | | IV | V | VI |
| Example 5 | Angle θ | 31 | 31 | | A | — | A |
| | Angle φ | 0 | 49 | | | | |
| | | First | Second | Third | | | |
| | | region | region | region | | | |
| Example 6 | Angle θ | 31 | 31 | 30 | A | A | A |
| | Angle φ | 0 | 29 | 50 | | | |

| | | Same through entire surface | | | |
|---|---|---|---|---|---|
| Comparative | Angle θ | 31 | A | B | C |
| Example 2 | Angle φ | 0 | | | |

As shown in Table 2, it was confirmed that, in the light absorption anisotropic films according to the embodiment of the present invention, the visibility of the displayed image was excellent in all positions IV to VI and the effect of the present invention was excellent.

### Explanation of References

1: dichroic substance

10, 20, 30, 40: light absorption anisotropic film

11, 21, 41, 51, 61, 81: first region

12, 22, 42, 52, 62, 82: second region

23, 63: third region

30a: center portion

30b: end portion

50, 60, 70, 80: alignment film

100, 200, 300: image display device

110, 210: optical film with barrier layer

112: pressure sensitive adhesive sheet

120: glass plate

131: first pane(image display panel)

132: second pane(image display panel)

L: boundary line

M: mask

What is claimed is:

1. A light absorption anisotropic film comprising:
a dichroic substance; and
a liquid crystal compound,
wherein the light absorption anisotropic film has a plurality of regions having different directions of transmittance central axes in an in-plane direction of the light absorption anisotropic film,
in the plurality of regions, all angles θ between the transmittance central axes and a normal direction of a surface of the light absorption anisotropic film are in a range of 0° to 70°, and
any of a requirement 1, a requirement 2, or a requirement 3 is satisfied,
the requirement 1: the angle θ in at least one of the plurality of regions is 0°,
the requirement 2: in at least two regions among the plurality of regions, directions of orthographic projection of the transmittance central axes onto the surface of the light absorption anisotropic film are the same, and in the at least two regions, the angles θ are different from each other,
the requirement 3: in at least two regions among the plurality of regions, the angles θ are the same, and in the at least two regions, directions of orthographic projection of the transmittance central axes onto the surface of the light absorption anisotropic film are different from each other.

2. The light absorption anisotropic film according to claim 1,
wherein the requirement 1 or the requirement 2 is satisfied.

3. The light absorption anisotropic film according to claim 2,
wherein the angles θ increase in a stepwise manner or a continuous manner or decrease in a stepwise manner or a continuous manner as proceeding in the in-plane direction in which the plurality of regions are arranged.

4. The light absorption anisotropic film according to claim 2,
wherein the angles θ in the light absorption anisotropic film increase in a continuous manner or decrease in a continuous manner as proceeding in the in-plane direction in which the plurality of regions are arranged.

5. The light absorption anisotropic film according to claim 3,
wherein the angles θ in the light absorption anisotropic film increase in a continuous manner or decrease in a continuous manner as proceeding in the in-plane direction in which the plurality of regions are arranged.

6. The light absorption anisotropic film according to claim 1,
wherein the requirement 3 is satisfied.

7. The light absorption anisotropic film according to claim 6,
wherein, as proceeding from a first region included in the at least two regions toward another region other than the first region along the in-plane direction in which the at least two regions are arranged, angles φ between the directions of orthographic projection of the transmittance central axes and the in-plane direction increase in a stepwise manner or a continuous manner or decrease in a stepwise manner or a continuous manner.

8. The light absorption anisotropic film according to claim 6,
wherein, as proceeding from a first region included in the at least two regions toward another region other than the first region along the in-plane direction in which the at least two regions are arranged, angles φ between the directions of orthographic projection of the transmittance central axes and the in-plane direction increase in a continuous manner or decrease in a continuous manner.

9. The light absorption anisotropic film according to claim 7,
wherein, as proceeding from the first region included in the at least two regions toward another region other than the first region along the in-plane direction in which the at least two regions are arranged, the angles φ between the directions of orthographic projection of the transmittance central axes and the in-plane direction increase in a continuous manner or decrease in a continuous manner.

10. An optical film comprising:
the light absorption anisotropic layer according to claim 1; and
an alignment film.

11. The optical film according to claim 10, further comprising:
a resin film containing polyvinyl alcohol or polyimide.

12. An image display device comprising:
a display panel; and
the optical film according to claim 10, which is disposed on one main surface of the display panel.

13. The light absorption anisotropic film according to claim 3,
wherein the angles θ in the light absorption anisotropic film increase in a continuous manner or decrease in a continuous manner as proceeding in the in-plane direction in which the plurality of regions are arranged.

14. The light absorption anisotropic film according to claim 7,
wherein, as proceeding from a first region included in the at least two regions toward another region other than the first region along the in-plane direction in which the at least two regions are arranged, angles φ between the directions of orthographic projection of the transmittance central axes and the in-plane direction increase in a stepwise manner or a continuous manner or decrease in a stepwise manner or a continuous manner.

15. An optical film comprising:
the light absorption anisotropic layer according to claim 2; and
an alignment film.

16. The optical film according to claim 15, further comprising:
a resin film containing polyvinyl alcohol or polyimide.

17. An image display device comprising:
a display panel; and
the optical film according to claim 11, which is disposed on one main surface of the display panel.

18. An image display device comprising:
a display panel; and
the optical film according to claim 15, which is disposed on one main surface of the display panel.

19. An optical film comprising:
the light absorption anisotropic layer according to claim 3; and
an alignment film.

20. The optical film according to claim 19, further comprising:
a resin film containing polyvinyl alcohol or polyimide.
